(19) United States
(12) Patent Application Publication
(10) Pub. No.: US 2015/0355563 A1
(43) Pub. Date: Dec. 10, 2015

(54) TONER

(71) Applicant: CANON KABUSHIKI KAISHA, Tokyo (JP)

(72) Inventors: Kenji Aoki, Mishima-shi (JP); Atsushi Tani, Suntou-gun (JP); Takaaki Kaya, Suntou-gun (JP); Ayako Okamoto, Wako-shi (JP); Takashige Kasuya, Numazu-shi (JP)

(21) Appl. No.: 14/832,436

(22) Filed: Aug. 21, 2015

Related U.S. Application Data
(62) Division of application No. 13/811,241, filed on Jan. 18, 2013.

(30) Foreign Application Priority Data
Jul. 22, 2010 (JP) 2010-165305

(51) Int. Cl. G03G 9/087; G03G 9/08

(52) U.S. Cl. CPC G03G 9/08755; G03G 9/0804

(57) ABSTRACT

In the measurement of an endothermic amount of a toner, (1) an endothermic peak temperature (Tp) derived from the binder resin is 50° C. or higher and 80° C. or lower; (2) a total endothermic amount (ΔH) derived from the binder resin is 30 [J/g] or more and 125 [J/g] or less based on mass of the binder resin; (3) when an endothermic amount derived from the binder resin from an initiation temperature of an endothermic process to Tp is represented by ΔH_{Tp} [J/g], ΔH and ΔH_{Tp} satisfy formula (1) below; and (4) when an endothermic amount derived from the binder resin from the initiation temperature of an endothermic process to a temperature 3.0° C. lower than Tp is represented by ΔH_{Tp-3} [J/g], ΔH and ΔH_{Tp-3} satisfy formula (2) below.

0.30≦ΔH_{Tp}/ΔH≦0.50 (1)

0.00≦ΔH_{Tp-3}/ΔH≦0.20 (2)

### CROSS REFERENCE TO RELATED APPLICATIONS

This application is a Divisional of U.S. patent application Ser. No. 13/811,241 filed Jan. 18, 2013, and which was a National Stage Entry of PCT/JP2011/066645 filed on Jul. 14, 2011, which claims priority to Japanese Patent Application No. 2010-165305 filed Jul. 22, 2010, all of which are hereby incorporated by reference herein in their entireties.

### TECHNICAL FIELD

The present invention relates to a toner used in electrophotography, electrostatic recording, or toner jet recording.

### BACKGROUND ART

In recent years, energy saving has been regarded as a significant technical issue even in electrophotographic apparatuses, and major reduction in the heat quantity required in fixing devices has been examined. Thus, a toner having so-called “low-temperature fixability” that allows fixation with lower energy has been increasingly demanded.

A decrease in the glass transition temperature (Tg) of a binder resin in a toner is exemplified as a method that allows fixation at low temperature. However, since a decrease in Tg leads to a decrease in the thermal storage resistance of toners, it is difficult to achieve both the low-temperature fixability and thermal storage resistance of toners by this method.

To achieve both the low-temperature fixability and thermal storage resistance of toners, a method that uses a crystalline polyester as a binder resin has been examined. Amorphous resins typically used as a binder resin for toners have no clear endothermic peak in the DSC measurement, but binder resins containing a crystalline resin component have an endothermic peak. Crystalline polyesters are hardly softened until their melting point because the molecular chain is regularly arranged. At a temperature higher than the melting point, the crystal is rapidly fused and thus the viscosity is rapidly decreased. Therefore, crystalline polyester has received attention as a material that has a good sharp-melting property and achieves both low-temperature fixability and thermal storage resistance.

PTL 1 discloses a toner contains, as a binder resin, a crystalline polyester resin having a melting point of 80° C. or higher and 140° C. or lower. However, this technology has a problem in that fixation in a lower temperature range cannot be achieved because the crystalline polyester has a high melting point.

To solve the problem above, PTL 2 discloses a technology that uses a binder resin obtained by mixing a crystalline polyester having a lower melting point and an amorphous substance. In the technology of PTL 2, a mixture of a crystalline polyester and a cycloolefin copolymer resin is used as a binder resin. However, since the ratio of the amorphous substance is high in this technology, the fixability is dependent on the Tg of the amorphous substance. Therefore, the sharp-melting property of the crystalline polyester cannot be sufficiently utilized.

PTLs 3, 4, and 5 disclose a technology that makes full use of the sharp-melting property of the crystalline polyester by employing the crystalline polyester as a main component of the binder resin. However, according to the examination conducted by the inventors of the present invention on the basis of the disclosures above, it was found that the melting point peak of the crystalline polyester in a toner was broad and thus the sharp-melting property of the crystalline polyester could not be effectively utilized. This is probably because, in this technology, a toner is produced through a heating step performed at a temperature higher than or equal to the melting point of the crystalline polyester, whereby the crystallinity is degraded.

As described above, there is still a problem before achieving both low-temperature fixability and thermal storage resistance.

### CITATION LIST

### Patent Literature

PTL 1 Japanese Patent Laid-Open No. 2002-318471

PTL 2 Japanese Patent Laid-Open No. 2006-276074

PTL 3 Japanese Patent Laid-Open No. 2004-191927

PTL 4 Japanese Patent Laid-Open No. 2005-234046

PTL 5 Japanese Patent Laid-Open No. 2006-084843

### SUMMARY OF INVENTION

### Technical Problem

In view of the foregoing, the present invention provides a toner that has good low-temperature fixability and high thermal storage resistance and in which a decrease in the fixability caused during the long-term storage is suppressed.

### Solution to Problem

Accordingly, an aspect of the present invention is described below.

According to an aspect of the present invention, there is provided a toner comprising toner particles, each of which contains a binder resin, a coloring agent, and a wax,

wherein the binder resin contains a resin (a) having a polyester unit in an amount of 50% or more by mass; and

wherein, when an endothermic amount of the toner is measured with a differential scanning calorimeter,

(1) an endothermic peak temperature (Tp) derived from the binder resin is 50° C. or higher and 80° C. or lower;

(2) a total endothermic amount (ΔH) derived from the binder resin is 30 [J/g] or more and 125 [J/g] or less based on mass of the binder resin;

(3) when an endothermic amount derived from the binder resin from an initiation temperature of an endothermic process to Tp is represented by ΔH_{Tp} [J/g], ΔH and ΔH_{Tp} satisfy formula (1) below; and

(4) when an endothermic amount derived from the binder resin from the initiation temperature of an endothermic process to a temperature 3.0° C. lower than Tp is represented by ΔH_{Tp-3} [J/g], ΔH and ΔH_{Tp-3} satisfy formula (2) below.

0.30≦ΔH_{Tp}/ΔH≦0.50 (1)

0.00≦ΔH_{Tp-3}/ΔH≦0.20 (2)

### Advantageous Effects of Invention

According to the present invention, there can be provided a toner that is excellent in a sharp-melting property and low-temperature fixability. There can also be provided a toner that is excellent in thermal storage resistance and long-term storage stability.

### BRIEF DESCRIPTION OF DRAWINGS

FIG. 1 is a schematic view showing an example of a production apparatus of a toner according to an aspect of the present invention.

FIG. 2 is a graph of a DSC endothermic peak of the toner according to an aspect of the present invention, the graph being used for describing ΔH_{Tp} and ΔH_{Tp-3}.

FIG. 3 is a DSC curve of toners in Example 1 and Comparative Example 3.

### DESCRIPTION OF EMBODIMENT

A toner according to an aspect of the present invention contains, as a binder resin, a resin (a) having a polyester unit in an amount of 50% or more by mass. The resin (a) is a crystalline resin.

Herein, a crystalline resin is a resin having a structure in which polymer molecular chains are regularly arranged. Such a crystalline resin has a clear endothermic peak derived from its melting point in the measurement of endothermic amount that uses a differential scanning calorimeter (DSC).

In the toner according to an aspect of the present invention, the endothermic peak temperature (Tp) derived from the binder resin is 50° C. or higher and 80° C. or lower in the measurement of the endothermic amount of the toner that uses a differential scanning calorimeter (DSC).

In the toner according to an aspect of the present invention, a peak temperature (Tp) is the melting point of a crystalline resin component.

In the present invention, as described in detail below, a crystalline resin component is a resin component containing a crystalline polyester segment.

The crystalline polyester has a crystalline structure in which polymer molecular chains are regularly arranged. Such a crystalline polyester is hardly softened at a temperature lower than the melting point, and is fused around the melting point and rapidly softened. Therefore, the crystalline polyester is a resin having a sharp-melting property.

If the endothermic peak temperature (Tp) is lower than 50° C., the low-temperature fixability is improved, but the thermal storage resistance of toners is significantly degraded. Furthermore, the aggregation easily occurs at high temperature and humidity, which results in a decrease in the image density. To further improve the thermal storage resistance, the peak temperature (Tp) is preferably 55° C. or higher. If the peak temperature (Tp) is higher than 80° C., the thermal storage resistance is improved, but the low-temperature fixability is degraded. The peak temperature (Tp) is more preferably 70° C. or lower.

In the present invention, the Tp can be adjusted by selecting the types and combination of monomers used for the synthesis of the crystalline polyester.

In the toner according to an aspect of the present invention, the total endothermic amount (ΔH) derived from the binder resin is 30 [J/g] or more and 125 [J/g] or less based on mass of the binder resin. Since the ΔH of typical crystalline polyesters is at most about 125 [J/g], the upper limit is specified just to be sure. The ΔH shows the ratio of a crystalline substance that is present in a crystalline state in the toner relative to the entire binder resin. That is, even if a large amount of crystalline substance is provided in the toner, the ΔH is low when the crystallinity is impaired. Therefore, when the ΔH is within the above-described range, the ratio of the crystalline resin that is present in a crystalline state in the toner is appropriate and thus good low-temperature fixability can be achieved. If the ΔH is less than 30 [J/g], the ratio of an amorphous resin component is relatively increased. As a result, the effects of the glass transition temperature (Tg) derived from the amorphous resin component become larger than those of the sharp-melting property of the crystalline polyester. Thus, it is difficult to achieve good low-temperature fixability. The upper limit of the ΔH is preferably 80 [J/g] or less. If the ΔH is more than 80 [J/g], the ratio of the crystalline resin is increased and thus the dispersion of a coloring agent in the toner is easily inhibited.

In the toner according to an aspect of the present invention, when the endothermic amount derived from the binder resin from the initiation temperature of the endothermic process to Tp is represented by ΔH_{Tp} [J/g], ΔH and ΔH_{Tp} satisfy the following formula (1).

0.30≦ΔH_{Tp}/ΔH≦0.50 (1)

Since the crystalline polyester is a polymer and thus does not have a completely ordered structure, the endothermic curve (endothermic peak) is broadened to the lower and higher temperature sides and has a certain temperature width. In particular, typical crystalline polyesters are affected by low-molecular-weight components or components having low crystallinity and have a peak highly broadened to the lower temperature side. Therefore, even if a toner contains a resin having appropriate Tp, components that broaden the peak of the toner to the lower temperature side soften the toner. As a result, the thermal storage resistance is degraded. Furthermore, since the crystallinity and characteristics of such components change after long-term storage, such components affect the fixability.

The ΔH_{Tp}/ΔH in the formula (1) indicates the magnitude of the broadening of a DSC endothermic peak. In other words, when the ΔH_{Tp}/ΔH is low, the broadening on the lower temperature side is small. When the ΔH_{Tp}/ΔH is high, the broadening on the lower temperature side is large.

When the ΔH_{Tp}/ΔH is 0.30 or more and 0.50 or less, the broadening on the lower and higher temperature sides is small, which provides a highly crystalline state. Therefore, there is provided a toner whose crystallinity is not easily degraded even after the long-term storage and that has stable fixability and thermal storage resistance for a long time. If the ΔH_{Tp}/ΔH is more than 0.50, the endothermic peak is broadened to the lower temperature side and the thermal storage resistance becomes poor. Furthermore, after the long-term storage, the crystallinity is impaired and the low-temperature fixability and thermal storage resistance are degraded. Aggregation also easily occurs at high temperature, which may result in a decrease in the image density. If the ΔH_{Tp}/ΔH is less than 0.30, the endothermic peak is broadened to the higher temperature side. Consequently, the sharp-melting property is not achieved and thus the low-temperature fixability is degraded.

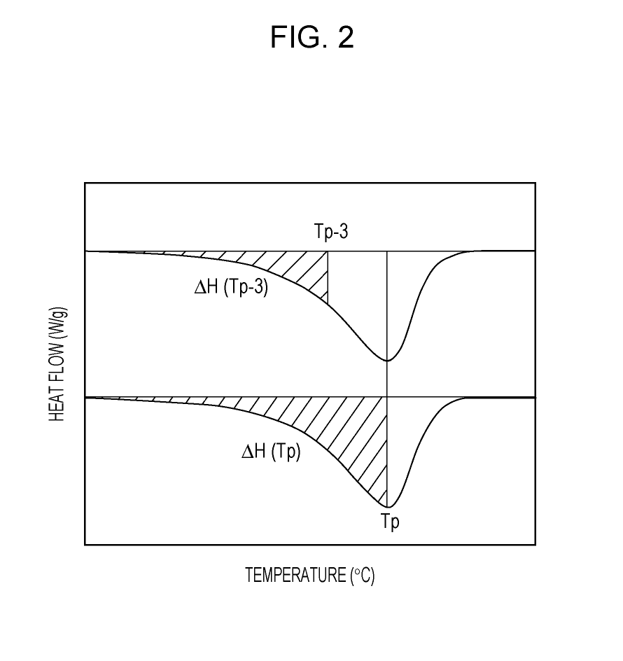

In the toner according to an aspect of the present invention, when the endothermic amount derived from the binder resin from the initiation temperature of an endothermic process to a temperature 3.0° C. lower than the peak temperature (Tp) is represented by ΔH_{Tp-3} [J/g], ΔH and ΔH_{Tp-3} satisfy the following formula (2) (refer to FIG. 2).

0.00≦ΔH_{Tp-3}/ΔH≦0.20 (2)

The ΔH_{Tp-3}/ΔH focuses on the lower temperature side of the endothermic peak. That is, when the ΔH_{Tp-3}/ΔH is within the above-described range, the broadening of the endothermic peak on the lower temperature side becomes small. As a result, the thermal storage resistance can be sufficiently satisfied. More preferably, 0.00≦ΔH_{Tp-3}/ΔH≦0.10.

When the endothermic initiation temperature of the endothermic peak is higher than a temperature 3.0° C. lower than Tp, the ΔH_{Tp-3} is regarded as 0.00 [J/g].

To control the ΔH_{Tp}/ΔH and ΔH_{Tp-3}/ΔH to be within their appropriate ranges, the crystallinity of the crystalline polyester needs to be increased in the production of toner particles. Specifically, a method for producing toner particles without heat treatment is effective. However, crystallinity can be increased by performing heat treatment at a temperature lower than the melting point of the crystalline polyester after the production of toner particles. Hereinafter, this heat treatment is referred to as an “annealing treatment”.

In general, it is known that the crystallinity of crystalline materials is increased by performing an annealing treatment. The mechanism is believed to be as follows. Since the molecular mobility of the polymer chain of the crystalline polyester is increased to some degree during the annealing treatment, the polymer chain is reoriented to a stable structure, that is, an ordered crystalline structure. Recrystallization occurs through this action. The recrystallization does not occur at a temperature higher than or equal to the melting point because the polymer chain has energy higher than the energy required for forming a crystalline structure.

Thus, since the annealing treatment in the present invention activates the molecular mobility of the crystalline polyester component in the toner as much as possible, it is important to perform the annealing treatment within a limited temperature range relative to the melting point of the crystalline polyester component. In this case, the annealing treatment temperature may be determined in accordance with the endothermic peak temperature derived from the crystalline polyester component, the endothermic peak temperature being determined by the DSC measurement of toner particles produced in advance. Specifically, the annealing treatment is preferably performed at a temperature that is higher than or equal to the temperature obtained by subtracting 15° C. from the peak temperature and that is lower than or equal to the temperature obtained by subtracting 5° C. from the peak temperature. Herein, the peak temperature is determined by DSC measurement under the condition that the temperature increasing rate is 10.0° C./min. The annealing treatment is more preferably performed at a temperature that is higher than or equal to the temperature obtained by subtracting 10° C. from the peak temperature and that is lower than or equal to the temperature obtained by subtracting 5° C. from the peak temperature.

The annealing treatment time can be suitably adjusted in accordance with the ratio, type, and crystal state of the crystalline polyester component in the toner. Normally, the annealing treatment time is preferably 0.5 hours or longer and 50 hours or shorter. If the annealing treatment time is shorter than 0.5 hours, the recrystallization is not easily achieved. The annealing treatment time is more preferably 5 hours or longer and 24 hours or shorter.

In the toner according to an aspect of the present invention, the half width of the endothermic peak derived from the binder resin in the toner is preferably 5.0° C. or lower. When the half width is 5.0° C. or lower, the change of state of the crystal does not easily occur and thus good fixability and thermal storage resistance can be maintained even after the long-term storage.

The toner according to an aspect of the present invention preferably has a number-average molecular weight (Mn) of 8000 or more and 30000 or less and a weight-average molecular weight (Mw) of 15000 or more and 60000 or less, which are determined by measuring THF-soluble components by gel permeation chromatography (GPC). Within the above-described range, good thermal storage resistance can be maintained and proper viscoelasticity can be imparted to the toner. The Mn is more preferably 10000 or more and 20000 or less and the Mw is more preferably 20000 or more and 50000 or less. Furthermore, Mw/Mn is preferably 6 or less and more preferably 3 or less.

In the present invention, the resin (a) mainly composed of polyester can be a copolymer obtained by chemically bonding a segment capable of forming a crystalline structure and a segment not forming a crystalline structure to each other. Examples of the copolymer include a block polymer, a graft polymer, and a star polymer. In particular, a block polymer can be employed. A block polymer is a polymer obtained by bonding polymers to each other through a chemical bond in a single molecule. A segment capable of forming a crystalline structure is a segment that, when many of such a segment gather, produces crystallinity through an ordered arrangement, which means a crystalline polymer chain. Herein, the segment is a crystalline polyester chain. A segment not forming a crystalline structure is a segment that is not regularly arranged even if such segments gather, and forms a random structure, which means an amorphous polymer chain.

Assuming that, for example, the crystalline polyester is “A” and the amorphous polymer is “B”, examples of the block polymer include AB diblock polymers, ABA triblock polymers, BAB triblock polymers, and ABAB . . . multiblock polymers. Since the crystalline polyester in a block polymer forms a fine domain in the toner, the sharp-melting property of the crystalline polyester is produced in the entire toner and thus low-temperature fixability is effectively achieved. Furthermore, such a fine domain structure can provide proper elasticity in a fixing temperature range after the sharp melting.

In the above-described block polymers, the segments capable of forming a crystalline structure are bonded to each other through a covalent bond such as an ester bond, a urea bond, and a urethane bond. Among them, a block polymer obtained by bonding the segments capable of forming a crystalline structure to each other through a urethane bond can be contained. The block polymer having a urethane bond can exhibit satisfactory elasticity even in a high temperature range.

The segment (hereinafter referred to as a “crystalline polyester segment”) capable of forming a crystalline structure in the block polymer will now be described.

The crystalline polyester segment can be composed of at least an aliphatic diol having 4 to 20 carbon atoms and a polyvalent carboxylic acid as raw materials.

Furthermore, a linear aliphatic diol can be employed as the aliphatic diol. Such a linear aliphatic diol easily increases the crystallinity of the toner and can easily satisfy the requirement of the present invention.

The following compounds can be exemplified as the aliphatic diol, but the aliphatic diol is not limited thereto. These compounds can be used in combination. Examples of the aliphatic diol include 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among them, 1,4-butanediol, 1,5-pentanediol, and 1,6-hexanediol can be employed in terms of melting point.

An aliphatic diol having a double bond can also be used. Examples of the aliphatic diol having a double bond include 2-butene-1,4-diol, 3-hexene-1,6-diol, and 4-octene-1,8-diol.

An aromatic dicarboxylic acid or an aliphatic dicarboxylic acid can be used as the polyvalent carboxylic acid. Among them, an aliphatic dicarboxylic acid can be favorably used. In terms of crystallinity, a linear dicarboxylic acid can be particular used.

The following compounds can be exemplified as the aliphatic dicarboxylic acid, but the dicarboxylic acid is not limited thereto. These compounds can be used in combination. Examples of the dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, 1,18-octadecanedicarboxylic acid, and the lower alkyl esters and acid anhydrides of the foregoing. Among them, sebacic acid, adipic acid, 1,10-decanedicarboxylic acid, and the lower alkyl esters and acid anhydrides of the foregoing can be particularly employed.

Examples of the aromatic dicarboxylic acid include terephthalic acid, isophthalic acid, 2,6-naphthalene dicarboxylic acid, and 4,4′-biphenyldicarboxylic acid. Among them, terephthalic acid can be particular employed in terms of availability and ease of formation of polymers having a low melting point.

A dicarboxylic acid having a double bond can also be used. Examples of the dicarboxylic acid include, but are not limited to, fumaric acid, maleic acid, 3-hexenedioic acid, 3-octenedioic acid, and the lower alkyl esters and acid anhydrides of the foregoing. Among them, fumaric acid and maleic acid can be particular used in terms of cost.

A method for producing the crystalline polyester segment is not particularly limited. The crystalline polyester segment can be produced by a typical polyester polymerization method in which an acid component and an alcohol component are caused to react with each other. A direct polycondensation method and a transesterification method may be selected in accordance with the types of monomers.

The crystalline polyester segment can be produced at a polymerization temperature of 180° C. or higher and 230° C. or lower. If necessary, the pressure of the reaction system can be reduced and the reaction can be caused to proceed while water and alcohols generated during condensation are removed. In the case where the monomers are not soluble or compatible at a reaction temperature, a solvent having a high boiling point may be added as a solubilizing agent to dissolve the monomers. The polycondensation reaction is caused while the solubilizing agent is distilled off. In the case where a monomer having poor compatibility is present in the copolymerization reaction, the monomer having poor compatibility is condensed beforehand with an acid or alcohol to be subjected to polycondensation with that monomer, and then the monomer having poor compatibility can be subjected to polycondensation with a main component.

Examples of a catalyst that can be used in the production of the crystalline polyester segment include titanium catalysts such as titanium tetraethoxide, titanium tetrapropoxide, titanium tetraisopropoxide, and titanium tetrabutoxide; and tin catalysts such as dibutyltin dichloride, dibutyltin oxide, and diphenyltin oxide.

The crystalline polyester segment can have an alcohol terminal to prepare the above-described block polymer. Therefore, the crystalline polyester can be prepared so that the molar ratio (alcohol component/carboxylic acid component) of the alcohol component to the acid component is 1.02 or more and 1.20 or less.

The segment (hereinafter referred to as an “amorphous polymer segment”) not forming a crystalline structure in the resin (a) will now be described. The glass transition temperature Tg of an amorphous resin that forms the amorphous polymer segment is preferably 50° C. or higher and 130° C. or lower and more preferably 70° C. or higher and 130° C. or lower. Within the above-described range, proper elasticity in a fixing temperature range is easily retained.

Examples of the amorphous resin that forms the amorphous polymer segment include, but are not limited to, polyurethane resin, polyester resin, styrene-acrylic resin, polystyrene resin, and styrene-butadiene resin. These resins may also be modified with urethane, urea, or epoxy. Among them, polyester resin and polyurethane resin can be suitably used in terms of retention of elasticity.

Examples of monomers used for a polyester resin serving as the amorphous resin include divalent or higher carboxylic acids and dihydric or higher alcohols described in “Polymer Data Handbook: Kiso-hen (Basic)” (edited by The Society of Polymer Science, Japan; BAIFUKAN Co., Ltd.). The following compounds can be exemplified as the monomer components. Examples of the divalent carboxylic acid include dibasic acids such as succinic acid, adipic acid, sebacic acid, phthalic acid, isophthalic acid, terephthalic acid, malonic acid, and dodecenylsuccinic acid; the anhydrides and lower alkyl esters of the foregoing; and unsaturated aliphatic dicarboxylic acids such as maleic acid, fumaric acid, itaconic acid, and citraconic acid. Examples of the trivalent or higher carboxylic acids include 1,2,4-benzenetricarboxylic acids and the anhydrides and lower alkyl esters thereof. These compounds may be used alone or in combination.

Examples of the dihydric alcohol include bisphenol A, hydrogenated bisphenol A, ethyleneoxide of bisphenol A, propylene oxide adducts of bisphenol A, 1,4-cyclohexanediol, 1,4-cyclohexanedimethanol, ethylene glycol, and propylene glycol. Examples of the trihydric or higher alcohols include glycerin, trimethylolethane, trimethylolpropane, and pentaerythritol. These compounds may be used alone or in combination. If necessary, a monovalent acid such as acetic acid or benzoic acid and a monohydric alcohol such as cyclohexanol or benzyl alcohol can also be used in order to adjust the acid value and the hydroxyl value.

The polyester resin serving as the amorphous resin can be synthesized by a publicly known method using the monomer components.

A polyurethane resin serving as the amorphous resin is described. The polyurethane resin is a product of a diol and a substance having a diisocyanate group. A polyurethane resin having multifunctionality can be obtained by adjusting the diol and diisocyanate.

Examples of the diisocyanate component include aromatic diisocyanates having 6 to 20 carbon atoms (excluding the carbon atom in an NCO group, the same applies hereinafter), aliphatic diisocyanates having 2 to 18 carbon atoms, alicyclic diisocyanates having 4 to 15 carbon atoms, modified products of these diisocyanates (modified products having a urethane group, a carbodiimide group, an allophanate group, a urea group, a biuret group, a uretdione group, a urethoimine group, an isocyanurate group, or an oxazolidone group, hereinafter referred to as “modified diisocyanates”), and mixtures containing two or more of the foregoing.

Examples of the aliphatic diisocyanates include ethylene diisocyanate, tetramethylene diisocyanate, hexamethylene diisocyanate (HDI), and dodecamethylene diisocyanate.

Examples of the alicyclic diisocyanates include isophorone diisocyanate (IPDI), dicyclohexylmethane-4,4′-diisocyanate, cyclohexylene diisocyanate, and methylcyclohexylene diisocyanate.

Examples of the aromatic diisocyanates include m- and/or p-xylylene diisocyanate (XDI) and α,α,α′,α′-tetramethylxylylene diisocyanate.

Among them, aromatic diisocyanates having 6 to 15 carbon atoms, aliphatic diisocyanates having 4 to 12 carbon atoms, alicyclic diisocyanates having 4 to 15 carbon atoms, and aromatic aliphatic diisocyanates can be used. In particular, HDI, IPDI, and XDI can be used.

For the polyurethane resin, a trifunctional or higher isocyanate compound can be used instead of the diisocyanate component.

Examples of the diol component that can be used for the polyurethane resin include alkyleneglycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide or propylene oxide) adducts of the alicyclic diols. The alkyl moiety of the alkylene ether glycols may be linear or branched. In the present invention, alkyleneglycols having a branched structure can also be used.

In the present invention, the block polymer can be prepared by a method in which a segment that forms a crystalline portion and a segment that forms an amorphous portion are separately prepared and then both the segments are bonded to each other (two-stage method) and a method in which raw materials of a segment that forms a crystalline portion and a segment that forms an amorphous portion are simultaneously prepared and a block polymer is formed at a time (single-stage method).

The block polymer according to an aspect of the present invention can be prepared by selecting a suitable method from various methods in consideration of the reactivity of the terminal functional groups.

In the case where the crystalline segment and the amorphous segment are composed of a polyester resin, the block polymer can be prepared by a method in which the segments are separately prepared and then both the segments are bonded to each other using a binding agent. In particular, when one of the polyester segments has a high acid value and the other has a high hydroxyl value, the reaction smoothly proceeds. The reaction can be caused at about 200° C.

Examples of the binding agent optionally used include polyvalent carboxylic acids, polyhydric alcohols, polyvalent isocyanates, multifunctional epoxy, and polyvalent acid anhydrides. The polyester resin can be synthesized through a dehydration reaction or an addition reaction using such a binding agent.

In the case where the amorphous resin is a polyurethane resin, the block polymer can be prepared by a method in which the segments are separately prepared and then a urethane-forming reaction is caused between the alcohol terminal of the crystalline polyester and the isocyanate terminal of the polyurethane. The block polymer can also be synthesized by mixing a crystalline polyester having an alcohol terminal with a diol and a diisocyanate constituting a polyurethane resin and then heating the mixture. At the initial stage of the reaction at which the diol and diisocyanate have high concentration, the diol and diisocyanate are selectively caused to react with each other to form a polyurethane resin. After the molecular weight is increased to some extent, a urethane-forming reaction is caused between the isocyanate terminal of the polyurethane resin and the alcohol terminal of the crystalline polyester to obtain a block polymer.

To effectively produce the effects of the block polymer, a polymer containing only the crystalline polyester or a polymer containing only the amorphous polymer should not be present in the toner. That is, the percentage of blocking is desirably as high as possible.

The resin (a) preferably contains the segment capable of forming a crystalline structure in an amount of 50% or more by mass relative to the total amount of the resin (a). In the case where the resin (a) is a block polymer, the composition ratio of the segment capable of forming a crystalline structure in the block polymer is preferably 50% or more by mass. When the content of the segment capable of forming a crystalline structure is within the above-described range, the sharp-melting property is easily produced effectively. The ratio of the segment capable of forming a crystalline structure relative to the total amount of the resin (a) is more preferably 60% or more and less than 85% by mass. The ratio of the amorphous polymer segment relative to the total amount of the resin (a) is preferably 10% or more and less than 50% by mass. In this case, elasticity after the sharp melting can be satisfactorily retained and thus the cause of high temperature offset is easily suppressed. The ratio is more preferably 15% or more and less than 40%.

In addition to the resin (a), another resin publicly known as a binder resin for toner may be contained as the binder resin according to an aspect of the present invention. The content is not particular limited as long as the endothermic amount derived from the binder resin is 30 [J/g] or more. As a guide, the resin (a) is contained in the binder resin in an amount of preferably 70% or more by mass and more preferably 85% or more by mass.

Examples of the wax used in the present invention include aliphatic hydrocarbon waxes such as low-molecular-weight polyethylene, low-molecular-weight polypropylene, low-molecular-weight olefin copolymers, microcrystalline wax, paraffin wax, and Fischer-Tropsch wax; oxides of aliphatic hydrocarbon waxes, such as oxidized polyethylene wax; waxes mainly composed of a fatty ester, such as aliphatic hydrocarbon ester wax; compounds obtained by deoxidizing part or the entire of a fatty ester, such as deoxidized carnauba wax; partially esterified compounds of a fatty acid and a polyhydric alcohol, such as behenic acid monoglyceride; and methyl ester compounds with a hydroxyl group that are obtained by hydrogenating vegetable oil and fat.

In the present invention, aliphatic hydrocarbon wax and ester wax can be particularly used in terms of ease of preparation of wax dispersion liquid, conformability in the toner produced, and the seeping property from the toner and mold-releasing property during fixation in a dissolving and suspending method.

In the present invention, any of natural ester wax and synthetic ester wax may be used as long as the ester wax has at least one ester bond in a single molecule.

An example of the synthetic ester wax is a monoester wax synthesized from a saturated long-chain linear fatty acid and a saturated long-chain linear alcohol. The saturated long-chain linear fatty acid is represented by general formula CₙH₂ₙ₊₁COOH, and a saturated long-chain linear fatty acid having n of 5 to 28 can be particularly used. The saturated long-chain linear alcohol is represented by general formula CₙH₂ₙ₊₁OH, and a saturated long-chain linear alcohol having n of 5 to 28 can be particularly used.

Examples of the natural ester wax include candelilla wax, carnauba wax, rice wax, and the derivatives thereof.

Among them, a synthetic ester wax obtained from a saturated long-chain linear fatty acid and a saturated long-chain linear fatty alcohol and a natural wax mainly composed of the above-described ester can be particularly used.

In the present invention, in addition to the linear structure, the ester can be suitably a monoester.

In the present invention, a hydrocarbon wax may also be used.

In the present invention, the content of the wax in the toner is preferably 2 parts or more and 20 parts or less by mass and more preferably 2 parts or more and 15 parts or less by mass relative to 100 parts by mass of the binder resin. When the content of the wax is within the above-described range, the releasing property of the toner is satisfactorily maintained and thus the winding of transfer paper can be suppressed. A decrease in the thermal storage resistance can also be suppressed.

In the differential scanning calorimetry (DSC), the wax according to an aspect of the present invention preferably has a peak temperature of the maximum endothermic peak at 60° C. or higher and 120° C. or lower and more preferably at 60° C. or higher and 90° C. or lower.

The toner according to an aspect of the present invention contains a coloring agent. Examples of the coloring agent that can be used in the present invention include organic pigments, organic dyes, and inorganic pigments. Examples of a black coloring agent include carbon black and magnetic powder. Other coloring agents that have been conventionally used for toner can also be used.

Examples of a yellow coloring agent include condensed azo compounds, isoindolinone compounds, anthraquinone compounds, azo metal complexes, methine compounds, and allylamide compounds. Specifically, C.I. Pigment Yellow 12, 13, 14, 15, 17, 62, 74, 83, 93, 94, 95, 109, 110, 111, 128, 129, 147, 168, or 180 can be used.

Examples of a magenta coloring agent include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, or 254 can be used.

Examples of a cyan coloring agent include copper phthalocyanine compounds and the derivatives thereof, anthraquinone compounds, and basic dye lake compounds. Specifically, C.I. Pigment Blue 1, 7, 15, 15:1, 15:2, 15:3, 15:4, 60, 62, or 66 can be used.

The coloring agent used for the toner according to an aspect of the present invention is selected in terms of hue angle, saturation, brightness, light resistance, OHP transparency, and dispersibility in the toner.

The coloring agent other than magnetic powder is preferably used in an amount of 1 part or more and 20 parts or less by mass relative to 100 parts by mass of the polymerizable monomer or binder resin. When magnetic powder is used as the coloring agent, the magnetic powder is preferably used in an amount of 40 parts or more and 150 parts or less by mass relative to 100 parts by mass of the polymerizable monomer or binder resin.

In the toner according to an aspect of the present invention, the toner particles may optionally contain a charge controlling agent. The charge controlling agent may be externally added to the toner particles. By adding the charge controlling agent, the charging characteristics can be stabilized and the frictional charge quantity can be suitably controlled in response to a developing system.

Publicly known charge controlling agents can be used, and a charge controlling agent that achieves quick charging and can stably maintain a constant charge quantity can be particularly used.

Examples of a charge controlling agent that permits the toner to be negatively chargeable include organometallic compounds, chelate compounds, monoazo metal compounds, metal acetylacetonate compounds, and metal compounds of aromatic oxycarboxylic acid, aromatic dicarboxylic acid, oxycarboxylic acid, and dicarboxylic acid. Examples of a charge controlling agent that permits the toner to be positively chargeable include nigrosine, quaternary ammonium salts, metal salts of higher fatty acids, diorganotin borate, guanidine compounds, and imidazole compounds.

The content of the charge controlling agent is preferably 0.01 parts or more and 20 parts or less by mass and more preferably 0.5 parts or more and 10 parts or less by mass relative to 100 parts by mass of the binder resin.

The toner according to an aspect of the present invention can be produced without performing heat treatment. The toner produced without performing heat treatment is a toner produced without exceeding the melting point of the crystalline polyester. The heat treatment performed when the crystalline polyester is produced is not taken into account. The crystallinity of the crystalline polyester tends to be impaired when heat treatment is performed at a temperature higher than or equal to the melting point. By producing a toner without performing heat treatment, the crystallinity of the crystalline polyester is easily maintained. As a result, the toner according to an aspect of the present invention can be achieved. An example of the toner production method without heat treatment is a dissolving and suspending method.

The dissolving and suspending method is a method in which a resin component is dissolved in an organic solvent, the resin solution is dispersed in a medium to form oil droplets, and then the organic solvent is removed to obtain toner particles.

In the production of the toner containing the crystalline polyester component according to an aspect of the present invention, high-pressure carbon dioxide can be used as a dispersion medium. That is, the above-described resin solution is dispersed in high-pressure carbon dioxide to perform granulation. The organic solvent contained in the granulated particles is removed by being extracted to the carbon dioxide phase. The carbon dioxide is separated by releasing the pressure to obtain toner particles. The high-pressure carbon dioxide suitably used in the present invention is liquid or supercritical carbon dioxide.

The term “liquid carbon dioxide” is carbon dioxide under temperature and pressure conditions indicated by a region on the phase diagram of carbon dioxide, the region being surrounded by a gas-liquid boundary line passing through the triple point (−57° C. and 0.5 MPa) and the critical point (31° C. and 7.4 MPa), an isothermal line of the critical temperature, and a solid-liquid boundary line. The term “supercritical carbon dioxide” is carbon dioxide at temperature and pressure higher than or equal to those of the critical point of carbon dioxide.

In the present invention, an organic solvent may be contained as another component in the dispersion medium. In this case, it is desirable that carbon dioxide and the organic solvent form a homogeneous phase.

In this method, since the granulation is performed under high pressure, the crystallinity of the crystalline polyester component can be easily maintained and furthermore can be improved.

A method for producing toner particles by using liquid or supercritical carbon dioxide as a dispersion medium will now be described. This method is suitable for obtaining the toner particles according to an aspect of the present invention.

First, a resin (a), a coloring agent, a wax, and optionally other additives are added to an organic solvent that can dissolve the resin (a) and dissolved or dispersed using a dispersing machine such as a homogenizer, a ball mill, a colloid mill, or an ultrasonic dispersing machine.

The resultant solution or dispersion liquid (hereinafter simply referred to as a “resin (a) solution”) is dispersed in liquid or supercritical carbon dioxide to form oil droplets.

Herein, a dispersant needs to be dispersed in the liquid or supercritical carbon dioxide serving as a dispersion medium. Examples of the dispersant include inorganic fine particle dispersants, organic fine particle dispersants, and the mixtures thereof. These dispersants may be used alone or in combination in accordance with the purpose.

Examples of the inorganic fine particle dispersants include inorganic particles of silica, alumina, zinc oxide, titania, and calcium oxide.

Examples of the organic fine particle dispersants include vinyl resin, urethane resin, epoxy resin, ester resin, polyamide, polyimide, silicone resin, fluorocarbon resin, phenol resin, melamine resin, benzoguanamine resin, urea resin, aniline resin, ionomer resin, polycarbonate, cellulose, and the mixtures thereof.

When the organic resin fine particles composed of an amorphous resin are used as a dispersant, carbon dioxide is dissolved in the organic resin fine particles and the plasticization of the resin is caused, resulting in a decrease in the glass transition temperature. As a result, particles are easily aggregated during the granulation. Thus, a crystalline resin can be used as the organic resin fine particles. When an amorphous resin is employed, a crosslinked structure can be introduced. Fine particles obtained by coating amorphous resin particles with a crystalline resin may also be used.

Although the dispersant may be used without pretreatment, the surface may be modified through a certain treatment to improve the adsorptivity of the dispersant to the surfaces of the oil droplets during the granulation. Examples of the treatment include a surface treatment using a silane coupling agent, a titanate coupling agent, or an aluminate coupling agent; a surface treatment using a surfactant; and a coating treatment using a polymer.

The dispersant adsorbed to the surfaces of the oil droplets is left thereon even after the formation of toner particles. Therefore, when the resin fine particles are used as a dispersant, toner particles whose surfaces are coated with the resin fine particles can be formed.

The number-average particle diameter of the resin fine particles is preferably 30 nm or more and 300 nm or less and more preferably 50 nm or more and 100 nm or less. If the particle diameter of the resin fine particles is excessively small, the stability of the oil droplets during the granulation tends to be degraded. If the particle diameter is excessively large, it becomes difficult to control the particle diameter of the oil droplets to be a desired particle diameter.

The content of the resin fine particles is preferably 3.0 parts or more and 15.0 parts or less by mass relative to the solid content of the resin (a) solution used for forming the oil droplets. The content can be suitably adjusted in accordance with the stability of oil droplets and the desired particle diameter.

In the present invention, a publicly known method may be used as a method for dispersing the dispersant in the liquid or supercritical carbon dioxide. Specifically, the dispersant and the liquid or supercritical carbon dioxide are inserted into a vessel, and the dispersion is directly performed by stirring or ultrasonic irradiation. Alternatively, a dispersion liquid obtained by dispersing the dispersant in an organic solvent is introduced, using a high-pressure pump, into a vessel into which the liquid or supercritical carbon dioxide has been inserted.

In the present invention, a publicly known method may be used as a method for dispersing the resin (a) solution in the liquid or supercritical carbon dioxide. Specifically, the resin (a) solution is introduced, using a high-pressure pump, into a vessel into which the liquid or supercritical carbon dioxide including the dispersant dispersed therein has been inserted. Alternatively, the liquid or supercritical carbon dioxide including the dispersant dispersed therein may be introduced into a vessel into which the resin (a) solution has been inserted.

In the present invention, it is important that the liquid or supercritical carbon dioxide serving as a dispersion medium has a single phase. When granulation is performed by dispersing the resin (a) solution in the liquid or supercritical carbon dioxide, part of the organic solvent in the oil droplets moves into the dispersion medium. Herein, if the carbon dioxide phase and the organic solvent phase are present in a separated manner, the stability of the oil droplets may be degraded. Therefore, the temperature and pressure of the dispersion medium and the ratio of the resin (a) solution to the liquid or supercritical carbon dioxide can be adjusted within the range in which the carbon dioxide and the organic solvent form a homogeneous phase.

Furthermore, caution needs to be taken to the temperature and pressure of the dispersion medium because the temperature and pressure affect the granulation property (ease of formation of oil droplets) and the solubility of the components of the resin (a) solution in the dispersion medium. For example, the resin (a) and wax in the resin (a) solution may be dissolved in the dispersion medium depending on the temperature and pressure conditions. Normally, the solubility of the components in the dispersion medium decreases at lower temperature and pressure. However, the formed oil droplets easily aggregate or coalesce, resulting in the degradation of the granulation property. On the other hand, the granulation property improves at higher temperature and pressure, but the components tend to be easily dissolved in the dispersion medium.

The temperature of the dispersion medium needs to be lower than the melting point of the crystalline polyester component in order to prevent the crystallinity of the crystalline polyester component from being impaired.

Thus, in the production of the toner particles according to an aspect of the present invention, the temperature of the dispersion medium is preferably 20° C. or higher and lower than the melting point of the crystalline polyester component.

The pressure in the vessel in which the dispersion medium is formed is preferably 3 MPa or more and 20 MPa or less and more preferably 5 MPa or more and 15 MPa or less. When components other than the carbon dioxide are contained in the dispersion medium, the pressure used in the present invention indicates a total pressure.

The ratio of the carbon dioxide in the dispersion medium is preferably 70% or more, more preferably 80% or more, and further preferably 90% or more by mass.

After the completion of the granulation, the organic solvent left in the oil droplets is removed through the liquid or supercritical carbon dioxide serving as the dispersion medium. Specifically, the dispersion medium including the oil droplets dispersed therein is further mixed with liquid or supercritical carbon dioxide to extract the residual organic solvent to the carbon dioxide phase. The carbon dioxide containing the organic solvent is replaced with another liquid or supercritical carbon dioxide.

When the dispersion medium is mixed with the liquid or supercritical carbon dioxide, liquid or supercritical carbon dioxide having higher pressure may be added to the dispersion medium, or the dispersion medium may be added to liquid or supercritical carbon dioxide having lower pressure.

The carbon dioxide containing the organic solvent is replaced with another liquid or supercritical carbon dioxide by a method in which liquid or supercritical carbon dioxide is caused to flow while the pressure in the vessel is kept constant. This is performed while the toner particles formed are being filtered.

If the replacement with the other liquid or supercritical carbon dioxide is not sufficient and thus the organic solvent is left in the dispersion medium, the organic solvent dissolved in the dispersion medium is condensed and the toner particles are dissolved again or aggregate with each other when the pressure of the vessel is reduced to collect the obtained toner particles. Therefore, the replacement with the other liquid or supercritical carbon dioxide needs to be performed until the organic solvent is completely removed. The volume of the other liquid or supercritical carbon dioxide caused to flow is preferably equal to or more than the volume of the dispersion medium and 100 times or less the volume, more preferably equal to or more than the volume and 50 times or less the volume, and most preferably equal to or more than the volume and 30 times or less the volume.

When the toner particles are extracted from the dispersion medium containing liquid or supercritical carbon dioxide in which the toner particles have been dispersed, the pressure and temperature of the vessel may be directly reduced to normal pressure and temperature. Alternatively, the pressure may be reduced in stages by providing multiple vessels whose pressure is independently controlled. The pressure-reducing rate can be freely set as long as the toner particles do not foam.

The organic solvent and liquid or supercritical carbon dioxide used in the present invention can be recycled.

Furthermore, in the present invention, there is performed a step of heating the extracted toner particles at a temperature lower than the melting point of the crystalline polyester (annealing step). The annealing step may be performed at any stage after the step of forming toner particles. For example, the annealing step may be performed on the particles in a slurry state, or may be performed before the external addition step or after the external addition step. Through the annealing step, the crystalline structure of the crystalline polyester component in the toner particles can be effectively improved.

An inorganic fine powder can be added to the toner particles as a flow improver.

Examples of the inorganic fine powder added to the toner particles include silica fine powder, titanium oxide fine powder, alumina fine powder, and the double oxide fine powder of the foregoing. Among them, silica fine powder and titanium oxide fine powder can be particularly used.

Examples of the silica fine powder include dry-process silica or fumed silica produced by vapor phase oxidation of silicon halides and wet-process silica produced from water glass. Dry-process silica can be suitably used as the organic fine powder because it has a small number of Na₂O and SO₃²⁻ and a small number of silanol groups that are present on the surface and inside the silica fine powder. The dry-process silica may be a compound fine powder of silica and other metal oxides, the compound fine powder being produced using metal halides such as aluminum chloride and titanium chloride together with silicon halides.

By hydrophobizing the inorganic fine powder, the control of the charge quantity of toner, an improvement in environmental stability, and an improvement in the characteristics in a high humidity environment can be achieved. Therefore, hydrophobized inorganic fine powder can be used.

Examples of an agent for hydrophobizing the inorganic fine powder include unmodified silicone varnish, various modified silicone varnishes, unmodified silicone oil, various modified silicone oils, silane compounds, silane coupling agents, organic silicon compounds, and organic titanium compounds. These agents may be used alone or in combination.

An inorganic fine powder treated with silicone oil can be particularly used. In addition, a hydrophobized inorganic fine powder obtained by simultaneously hydrophobizing an inorganic fine powder with a coupling agent and a silicone oil or by hydrophobizing an inorganic fine powder with a coupling agent and then treating the inorganic fine powder with a silicone oil can be used because the toner particles can have a high charge quantity even in a high humidity environment and the selective development is reduced.

The content of the inorganic fine powder is preferably 0.1 parts or more and 4.0 parts or less by mass and more preferably 0.2 parts or more and 3.5 parts or less by mass relative to 100 parts by mass of the toner particles.

The toner according to an aspect of the present invention preferably has a weight-average particle diameter (D4) of 3.0 μm or more and 8.0 μm or less and more preferably 5.0 μm or more and 7.0 μm or less. Such a toner having the weight-average particle diameter (D4) provides ease of handling and sufficiently satisfies the reproducibility of dots.

The ratio D4/D1 of the weight-average particle diameter (D4) to a number-average particle diameter (D1) of the toner according to an aspect of the present invention is preferably 1.25 or less and more preferably 1.20 or less.

The measurement method of various physical properties of the toner according to an aspect of the present invention will now be described.

### <Measurement Method of Weight-Average Particle Diameter (D4) and Number-Average Particle Diameter (D1)>

The weight-average particle diameter (D4) and number-average particle diameter (D1) of the toner are calculated as follows.

An accurate particle-diameter distribution analyzer “Coulter Counter Multisizer 3” (registered trademark, manufactured by Beckman Coulter, Inc.) including an aperture tube with a size of 100 μm and employing a pore electrical resistance method is used as a measurement apparatus. The measurement conditions are set and the measurement data is analyzed using attached dedicated software “Beckman Coulter Multisizer 3, Version 3.51” (manufactured by Beckman Coulter, Inc.). The number of effective measurement channels is 25000.

An aqueous electrolytic solution used in the measurement can be prepared by dissolving sodium chloride (guaranteed reagent) in ion-exchange water so that the concentration is about 1% by mass. For example, “ISOTON II” (manufactured by Beckman Coulter, Inc.) can be used.

Before the measurement and analysis, the dedicated software is set up as follows.

On the screen “Change of Standard Operation Method (SOM)” of the dedicated software, the total number of counts in the control mode is set to be 50000 particles, the number of measurement is set to be one, and a value obtained using “Standard Particles 10.0 μm” (manufactured by Beckman Coulter, Inc.) is set as a Kd value. By pressing “Measurement button of threshold/noise level”, the threshold and noise level are automatically set. The current is set to be 1600 μA, the gain is set to be 2, and the electrolytic solution is set to be ISOTON II. The item “Flushing of aperture tube after measurement” is ticked.

On the screen “Conversion setting from pulse to particle diameter” of the dedicated software, the bin interval is set to be logarithmic particle diameter, the particle diameter bin is set to be 256 bins, and the particle diameter range is set to be 2 μm to 60 μm.

The specific measurement method is described below.

(1) About 200 mL of the aqueous electrolytic solution is inserted into a 250 mL round-bottomed beaker (made of glass) for Multisizer 3. The beaker is mounted to a sample stand, and stirring is performed counterclockwise at 24 revolutions per second using a stirrer rod. The contamination and air bubbles in the aperture tube are removed using the “Flushing of aperture” function in the dedicated software.

(2) About 30 mL of the aqueous electrolytic solution is inserted into a 100 mL flat-bottomed beaker (made of glass). About 0.3 mL of diluted solution obtained by diluting “Contaminon N” (10 mass % aqueous solution of a neutral detergent for washing precision instruments composed of a nonionic surfactant, an anionic surfactant, and an organic builder, pH 7, manufactured by Wako Pure Chemical Industries, Ltd.) with ion-exchange water about three times by mass is added to the flat-bottomed beaker as a dispersant.

(3) There is prepared an ultrasonic dispersing device “Ultrasonic Dispersion System Tetora 150” (manufactured by Nikkaki-Bios Co., Ltd.) that has an electrical output of 120 W and includes two oscillators having an oscillation frequency of 50 kHz with phases being shifted 180 degrees. About 3.3 L of ion-exchange water is inserted into a tank of the ultrasonic dispersing device, and about 2 mL of Contaminon N is added to the tank.

(4) The flat-bottomed beaker is set in the beaker setting hole of the ultrasonic dispersing device, and then the ultrasonic dispersing device is operated. The level of the beaker is adjusted so that the resonant state of the liquid surface of the aqueous electrolytic solution in the beaker is maximized.

(5) About 10 mg of toner is gradually added to the aqueous electrolytic solution while ultrasonic waves are applied to the aqueous electrolytic solution in the flat-bottomed beaker. Thus, the toner is dispersed in the aqueous electrolytic solution. This ultrasonic dispersion treatment is continued for 60 seconds. In this ultrasonic dispersion, the water temperature in the tank is adjusted to be 10° C. or higher and 40° C. or lower.

(6) The aqueous electrolytic solution in which the toner has been dispersed is added dropwise, using a pipette, to the round-bottomed beaker mounted to the sample stand so that the measurement concentration becomes about 5%. The measurement is performed until the number of measured particles reaches 50000.

(7) The measured data is analyzed using the attached dedicated software to calculate the weight-average particle diameter (D4) and number-average particle diameter (D1). “Mean Diameter” on the “Analysis/Volume statistics (arithmetic mean)” screen displayed by selecting graph/vol % in the dedicated software is the weight-average particle diameter (D4). “Mean Diameter” on the “Analysis/Number statistics (arithmetic mean)” screen displayed by selecting graph/num % in the dedicated software is the number-average particle diameter (D1).

### <Measurement Method of Tp, ΔH, ΔH_{Tp}, ΔH_{Tp-3}, and Half Width>

The Tp, ΔH, ΔH_{Tp}, and ΔH_{Tp-3} of the toner and its material according to an aspect of the present invention are measured with DSC Q1000 (manufactured by TA Instruments) under the conditions below.

Temperature increasing rate: 10° C./min
Initiation temperature of measurement: 20° C.
End temperature of measurement: 180° C.

The temperature correction of the detector is performed using the melting points of indium and zinc, and the correction of heat quantity is performed using the heat of fusion of indium.

Specifically, about 5 mg of a sample is precisely weighed and placed on a pan made of silver to perform differential scanning calorimetry. A blank pan made of silver is used as a reference.

In the case where a toner is used as a sample, when the maximum endothermic peak (endothermic peak derived from a binder resin) does not overlap the endothermic peak of a wax, the obtained maximum endothermic peak is treated as an endothermic peak derived from a binder resin. In the case where a toner is used as a sample, when the maximum endothermic peak overlaps the endothermic peak of a wax, the endothermic amount derived from a wax needs to be subtracted from the maximum endothermic peak.

For example, the endothermic amount derived from a wax can be subtracted from the obtained maximum endothermic peak by the following method to obtain an endothermic peak derived from a binder resin.

First, DSC measurement is independently performed on a wax to determine the endothermic characteristics. The content of the wax in the toner is then determined. The measurement of the content of the wax in the toner is not particularly limited. For example, the content can be measured by the peak separation in the DSC measurement or publicly known structure analysis. Subsequently, the heat quantity derived from the wax is calculated from the content of the wax in the toner, and the heat quantity is subtracted from the maximum endothermic peak. In the case where the wax is compatible with the resin component, the heat quantity derived from the wax is calculated from the content of the wax multiplied by a compatible factor, and the heat quantity is subtracted from the maximum endothermic peak. The compatible factor is calculated from a value obtained by dividing an endothermic amount by a theoretical endothermic amount. The term “endothermic amount” is an endothermic amount of a mixture containing a fused mixture of a resin component and the wax at a certain ratio. The term “theoretical endothermic amount” is calculated from the endothermic amounts of the fused mixture and wax determined in advance.

In the measurement, to determine an endothermic amount per gram of the binder resin, the mass of the components other than the binder resin component needs to be subtracted from the mass of the sample.

The content of the components other than the resin component can be measured by a publicly known analytical method. If the analysis is difficult to conduct, the ash content of burned toner residue is determined. The amount obtained by adding the amount of the components, other than the binder resin, to be burned such as a wax to the ash content is regarded as the content of the components other than the binder resin. The content of the components other than the binder resin is subtracted from the mass of the toner.

The ash content of the burned toner residue is determined through the following process. About 2 g of toner is put into a 30 mL magnetic crucible weighed in advance. The crucible is inserted into an electric furnace, heated at about 900° C. for about 3 hours, allowed to cool in the electric furnace, and allowed to cool in a desiccator at room temperature for 1 hour or longer. The crucible containing ash of burned residue is weighed, and the mass of the crucible is subtracted from the mass of the crucible containing the ash to calculate the ash content of the burned residue.

If there are multiple peaks, the maximum endothermic peak is a peak having the maximum endothermic amount. The half width is a temperature width of an endothermic peak at half maximum.

### <Measurement Method of Mn and Mw>

The molecular weight (Mn and Mw) of the THF-soluble component of the toner and its material used in the present invention is measured by gel permeation chromatography (GPC).

First, a sample is dissolved in tetrahydrofuran (THF) at room temperature over 24 hours. The resultant solution is filtered using a solvent-resistant membrane filter “Maishori Disk” (manufactured by TOSOH CORPORATION) having a pore size of 0.2 μm to obtain a sample solution. The sample solution is prepared so that the concentration of the THF-soluble component is about 0.8% by mass. The measurement is performed using this sample solution under the conditions below.

Equipment: HLC8120 GPC (Detector: RI) (manufactured by TOSOH CORPORATION)
Column: seven successive columns of Shodex KF-801, 802, 803, 804, 805, 806, and 807 (manufactured by Showa Denko K.K.)
Eluent: tetrahydrofuran (THF)
Flow rate: 1.0 mL/min
Oven temperature: 40.0° C.
Sample injection volume: 0.10 mL

A molecular weight calibration curve prepared using standard polystyrene resins (e.g., Product name “TSK Standard Polystyrene F-850, F-450, F-288, F-128, F-80, F-40, F-20, F-10, F-4, F-2, F-1, A-5000, A-2500, A-1000, A-500” manufactured by TOSOH CORPORATION) is used to determine the molecular weight of the sample.

### <Measurement Method of Particle Diameter of Resin Fine Particles>

The number-average particle diameter (μm or nm) of the resin fine particles is measured with a Microtrac particle-diameter distribution analyzer HRA (X-100) (manufactured by NIKKISO Co., Ltd.) in the range of 0.001 μm to 10 μm. Water is selected as a diluent solvent.

### <Measurement Method of Melting Point of Wax>

The melting point of the wax is measured with DSC Q1000 (manufactured by TA Instruments) under the conditions below.

Temperature increasing rate: 10° C./min
Initiation temperature of measurement: 20° C.
End temperature of measurement: 180° C.

The temperature correction of the detector is performed using the melting points of indium and zinc, and the correction of heat quantity is performed using the heat of fusion of indium.

Specifically, about 2 mg of a wax is precisely weighed and placed on a pan made of silver to perform differential scanning calorimetry. A blank pan made of silver is used as a reference. In the measurement, the temperature is increased to 200° C. once, decreased to 30° C., and then increased again. In the second temperature increasing process, a temperature at the maximum endothermic peak in the DSC curve between 30 to 200° C. is regarded as the melting point of the wax. If there are multiple peaks, the maximum endothermic peak is a peak having the maximum endothermic amount.

### <Measurement Method of Ratio of Segment Capable of Forming Crystalline Structure>

The ratio of the segment capable of forming a crystalline structure in the resin (a) is measured by 1H-NMR under the conditions below.

Equipment: FT-NMR spectrometer, JNM-EX400 (manufactured by JEOL Ltd.)
Measurement frequency: 400 MHz
Pulse condition: 5.0 μsec
Frequency range: 10500 Hz
Number of acquisitions: 64
Measurement temperature: 30° C.
Sample: A test sample in an amount of 50 mg is inserted into a 5 mm-diameter sample tube and deuteriochloroform (CDCl₃) is added thereto as a solvent. The test sample is dissolved at 40° C. in a thermostat vessel.

In the obtained 1H-NMR chart, among the peaks that belong to the components of the segment capable of forming a crystalline structure, a peak independent of the peaks that belong to other components is selected and the integration value S₁ of the peak is calculated. Similarly, among the peaks that belong to the components of the amorphous segment, a peak independent of the peaks that belong to other components is selected and the integration value S₂ of the peak is calculated.

The ratio of the segment capable of forming a crystalline structure is determined using the integration values S₁ and S₂ as follows. Note that n₁ and n₂ are the number of hydrogen atoms in the components to which the peaks of the respective segments belong.

Ratio of segment capable of forming crystalline structure (mol %)={(S₁/n₁)/((S₁/n₁)+(S₂/n₂))}×100

The ratio of the segment capable of forming a crystalline structure (mol %) is converted into a ratio of the segment capable of forming a crystalline structure (mass %) using the molecular weight of the components.

The structure of the segment capable of forming a crystalline structure is analyzed by a publicly known method in a separated manner. In the resin (a) described in Examples, regarding the segment capable of forming a crystalline structure, the integration value of the peak derived from a diol component contained in the crystalline polyester component was used. Regarding the segment not forming a crystalline structure, the integration value of the peak derived from an isocyanate component was used.

### EXAMPLES

The present invention will now be specifically described based on Production Examples and Examples, but is not limited thereto.

### <Synthesis of Crystalline Polyester 1>

The following raw materials were put in a two-neck flask dried by heating while nitrogen was introduced.

| | |
|---|---|
| sebacic acid | 136.8 parts by mass |
| 1,4-butanediol | 63.2 parts by mass |
| dibutyltin oxide | 0.1 parts by mass |

After the system was purged with nitrogen by pressure reduction, stirring was performed at 180° C. for 6 hours. The temperature was gradually increased to 230° C. under reduced pressure while the stirring was performed. The temperature was further maintained for 2 hours. When the mixture became viscous, air cooling was performed to terminate the reaction. Thus, a crystalline polyester 1 was synthesized. Table 1 shows the physical properties of the crystalline polyester 1.

### <Synthesis of Crystalline Polyester 2>

A crystalline polyester 2 was synthesized in the same manner as in the synthesis of the crystalline polyester 1, except that the preparation of the raw materials was changed to be as follows. Table 1 shows the physical properties of the crystalline polyester 2.

| | |
|---|---|
| sebacic acid | 112.5 parts by mass |
| adipic acid | 22.0 parts by mass |
| 1,4-butanediol | 65.5 parts by mass |
| dibutyltin oxide | 0.1 parts by mass |

### <Synthesis of Crystalline Polyester 3>

A crystalline polyester 3 was synthesized in the same manner as in the synthesis of the crystalline polyester 1, except that the preparation of the raw materials was changed to be as follows. Table 1 shows the physical properties of the crystalline polyester 3.

| | |
|---|---|
| tetradecanedioic acid | 135.0 parts by mass |
| 1,6-hexanediol | 65.0 parts by mass |
| dibutyltin oxide | 0.1 parts by mass |

### <Synthesis of Crystalline Polyester 4>

A crystalline polyester 4 was synthesized in the same manner as in the synthesis of the crystalline polyester 1, except that the preparation of the raw materials was changed to be as follows. Table 1 shows the physical properties of the crystalline polyester 4.

| | |
|---|---|
| sebacic acid | 107.0 parts by mass |
| adipic acid | 27.0 parts by mass |
| 1,4-butanediol | 66.0 parts by mass |
| dibutyltin oxide | 0.1 parts by mass |

### <Synthesis of Crystalline Polyester 5>

A crystalline polyester 5 was synthesized in the same manner as in the synthesis of the crystalline polyester 1, except that the preparation of the raw materials was changed to be as follows. Table 1 shows the physical properties of the crystalline polyester 5.

| | |
|---|---|
| octadecanedioic acid | 152.6 parts by mass |
| 1,4-butanediol | 47.4 parts by mass |
| dibutyltin oxide | 0.1 parts by mass |

### <Synthesis of Crystalline Polyester 6>

A crystalline polyester 6 was synthesized in the same manner as in the synthesis of the crystalline polyester 1, except that the preparation of the raw materials was changed to be as follows. Table 1 shows the physical properties of the crystalline polyester 6.

| | |
|---|---|
| sebacic acid | 76.0 parts by mass |
| adipic acid | 55.0 parts by mass |
| 1,4-butanediol | 69.0 parts by mass |
| dibutyltin oxide | 0.1 parts by mass |

### <Synthesis of Crystalline Polyester 7>

A crystalline polyester 7 was synthesized in the same manner as in the synthesis of the crystalline polyester 1, except that the preparation of the raw materials was changed to be as follows. Table 1 shows the physical properties of the crystalline polyester 7.

| | |
|---|---|
| dodecanedioic acid | 112.2 parts by mass |
| 1,10-decanediol | 87.8 parts by mass |
| dibutyltin oxide | 0.1 parts by mass |

### <Synthesis of Crystalline Polyester 8>

A crystalline polyester 8 was synthesized in the same manner as in the synthesis of the crystalline polyester 1, except that the preparation of the raw materials was changed to be as follows. Table 1 shows the physical properties of the crystalline polyester 8.

| | |
|---|---|
| sebacic acid | 138.0 parts by mass |
| 1,4-butanediol | 62.0 parts by mass |
| dibutyltin oxide | 0.1 parts by mass |

TABLE 1

| | | | | | Properties of DSC | | |
|---|---|---|---|---|---|---|---|
| | Molar ratio | | | | maximum endothermic peak | | |
| | (alcohol | | | | Peak | Endothermic | |
| | component/acid | | | | temperature | amount | Half width |
| | component) | Mn | Mw | Mw/Mn | (° C.) | (J/g) | (° C.) |
| Crystalline | 1.05 | 4900 | 11300 | 2.3 | 66 | 118 | 3.6 |
| polyester 1 | | | | | | | |
| Crystalline | 1.05 | 5000 | 11500 | 2.3 | 61 | 112 | 3.5 |
| polyester 2 | | | | | | | |
| Crystalline | 1.06 | 4900 | 10800 | 2.2 | 74 | 123 | 3.8 |
| polyester 3 | | | | | | | |
| Crystalline | 1.04 | 5100 | 11200 | 2.2 | 58 | 113 | 3.6 |
| polyester 4 | | | | | | | |
| Crystalline | 1.07 | 4900 | 10800 | 2.2 | 83 | 113 | 3.4 |
| polyester 5 | | | | | | | |
| Crystalline | 1.04 | 5000 | 10500 | 2.1 | 50 | 120 | 3.6 |
| polyester 6 | | | | | | | |
| Crystalline | 1.07 | 5000 | 10500 | 2.1 | 87 | 110 | 3.7 |
| polyester 7 | | | | | | | |
| Crystalline | 1.02 | 12200 | 58600 | 4.8 | 65 | 120 | 5.1 |
| polyester 8 | | | | | | | |

### <Synthesis of Block Polymer 1>

| | |
|---|---|
| crystalline polyester 1 | 210.0 parts by mass |
| xylylene diisocyanate (XDI) | 56.0 parts by mass |
| cyclohexanedimethanol (CHDM) | 34.0 parts by mass |
| tetrahydrofuran (THF) | 300.0 parts by mass |

The above-described raw materials were put in a reactor including a stirring unit and a thermometer while the reactor was purged with nitrogen. The temperature was increased to 50° C. and a urethane-forming reaction was caused to proceed over 15 hours. Subsequently, 3.0 parts by mass of tertiary butyl alcohol (t-BuOH) was added to modify the isocyanate terminal. THF serving as a solvent was distilled off to obtain a block polymer 1. Table 3 shows the physical properties of the block polymer 1.

### <Synthesis of Block Polymers 2 to 18>

Block polymers 2 to 18 were synthesized in the same manner as in the synthesis of the block polymer 1, except that the types and parts of polyester used, the parts of XDI, CHDM, THF, and t-BuOH, and the reaction time and temperature were changed to those shown in Table 2. Table 3 shows the physical properties of the block polymers 2 to 18.

TABLE 2

| | | Formula | | | | | Reaction conditions | |
|---|---|---|---|---|---|---|---|---|
| | Crystalline segment | Crystalline | XDI | CHDM | t-BuOH | THF | Temperature | Time |
| | used | polyester (part) | (part) | (part) | (part) | (part) | (° C.) | (hour) |
| Block polymer 1 | Crystalline polyester 1 | 210.0 | 56.0 | 34.0 | 3.0 | 300.0 | 50 | 15 |
| Block polymer 2 | Crystalline polyester 2 | 210.0 | 56.0 | 34.0 | 3.0 | 300.0 | 50 | 15 |
| Block polymer 3 | Crystalline polyester 3 | 210.0 | 56.0 | 34.0 | 3.0 | 300.0 | 50 | 15 |
| Block polymer 4 | Crystalline polyester 4 | 210.0 | 56.0 | 34.0 | 3.0 | 300.0 | 50 | 15 |
| Block polymer 5 | Crystalline polyester 5 | 210.0 | 56.0 | 34.0 | 3.0 | 300.0 | 50 | 15 |
| Block polymer 6 | Crystalline polyester 1 | 234.0 | 43.0 | 23.0 | 3.0 | 300.0 | 50 | 15 |
| Block polymer 7 | Crystalline polyester 1 | 156.0 | 86.0 | 58.0 | 3.0 | 300.0 | 50 | 15 |
| Block polymer 8 | Crystalline polyester 4 | 156.0 | 86.0 | 58.0 | 3.0 | 300.0 | 50 | 15 |
| Block polymer 9 | Crystalline polyester 5 | 234.0 | 43.0 | 23.0 | 3.0 | 300.0 | 50 | 15 |
| Block polymer 10 | Crystalline polyester 1 | 210.0 | 57.0 | 33.0 | 3.0 | 300.0 | 50 | 15 |
| Block polymer 11 | Crystalline polyester 1 | 210.0 | 58.0 | 32.0 | 3.0 | 300.0 | 50 | 15 |
| Block polymer 12 | Crystalline polyester 1 | 210.0 | 55.5 | 34.5 | 3.0 | 300.0 | 50 | 15 |
| Block polymer 13 | Crystalline polyester 1 | 210.0 | 55.0 | 35.0 | 3.0 | 300.0 | 50 | 15 |
| Block polymer 14 | Crystalline polyester 1 | 258.0 | 30.0 | 12.0 | 3.0 | 300.0 | 50 | 15 |
| Block polymer 15 | Crystalline polyester 6 | 210.0 | 56.0 | 34.0 | 3.0 | 300.0 | 50 | 15 |
| Block polymer 16 | Crystalline polyester 7 | 210.0 | 56.0 | 34.0 | 3.0 | 300.0 | 50 | 15 |
| Block polymer 17 | Crystalline polyester 1 | 135.0 | 97.0 | 68.0 | 3.0 | 300.0 | 50 | 15 |
| Block polymer 18 | Crystalline polyester 1 | 210.0 | 56.0 | 34.0 | 3.0 | 300.0 | 45 | 20 |

XDI: xylylene diisocyanate
CHDM: cyclohexanedimethanol
t-BuOH: tertiary butyl alcohol
THF: tetrahydrofuran

TABLE 3

| | Ratio of | | | | |
|---|---|---|---|---|---|
| | crystalline | | | | Endothermic |
| | segment | | | | peak |
| | (% by | | | | temperature |
| | mass) | Mn | Mw | Mw/Mn | (° C.) |
| Block polymer 1 | 70 | 15900 | 33700 | 2.1 | 58 |
| Block polymer 2 | 70 | 15200 | 33000 | 2.2 | 53 |
| Block polymer 3 | 70 | 15900 | 31000 | 1.9 | 66 |
| Block polymer 4 | 70 | 14400 | 31000 | 2.2 | 50 |
| Block polymer 5 | 70 | 15900 | 35200 | 2.2 | 75 |
| Block polymer 6 | 78 | 14100 | 30900 | 2.2 | 58 |
| Block polymer 7 | 52 | 13100 | 29200 | 2.2 | 58 |
| Block polymer 8 | 52 | 12500 | 24800 | 2.0 | 50 |
| Block polymer 9 | 78 | 14100 | 33100 | 2.3 | 75 |
| Block polymer 10 | 70 | 9600 | 19800 | 2.1 | 58 |
| Block polymer 11 | 70 | 6900 | 14900 | 2.2 | 58 |
| Block polymer 12 | 70 | 28100 | 58100 | 2.1 | 58 |
| Block polymer 13 | 70 | 39800 | 73700 | 1.9 | 58 |
| Block polymer 14 | 86 | 12700 | 28400 | 2.2 | 58 |
| Block polymer 15 | 70 | 15300 | 34500 | 2.3 | 42 |
| Block polymer 16 | 70 | 15100 | 33000 | 2.2 | 79 |
| Block polymer 17 | 45 | 18500 | 41600 | 2.2 | 58 |
| Block polymer 18 | 70 | 15900 | 98000 | 6.2 | 58 |

### <Synthesis of Amorphous Resin 1>

| | |
|---|---|
| xylylene diisocyanate (XDI) | 117.0 parts by mass |
| cyclohexanedimethanol (CHDM) | 83.0 parts by mass |
| acetone | 200.0 parts by mass |

The above-described raw materials were put in a reactor including a stirring unit and a thermometer while the reactor was purged with nitrogen. The temperature was increased to 50° C. and a urethane-forming reaction was caused to proceed over 15 hours. Subsequently, 3.0 parts by mass of tertiary butyl alcohol was added to modify the isocyanate terminal. Acetone serving as a solvent was distilled off to obtain an amorphous resin 1. The resultant amorphous resin 1 has an Mn of 4400 and an Mw of 20000.

### <Preparation of Block Polymer Resin Solutions 1 to 18>

Into a beaker including a stirring unit, 500.0 parts by mass of acetone and 500.0 parts by mass of block polymer 1 were inserted. The block polymer 1 was completely dissolved in acetone by being stirred at 40° C. to prepare a block polymer resin solution 1.

Block polymer resin solutions 2 to 18 were prepared in the same manner as in the preparation of the block polymer resin solution 1, except that the block polymer 1 was changed to the block polymers 2 to 18, respectively.

### <Preparation of Crystalline Polyester Resin Solution 1>

Into a beaker including a stirring unit, 500.0 parts by mass of tetrahydrofuran (THF) and 500.0 parts by mass of crystalline polyester 8 were inserted. The crystalline polyester 8 was completely dissolved in THF by being stirred at 40° C. to prepare a crystalline polyester resin solution 1.

### <Preparation of Amorphous Resin Solution 1>

Into a beaker including a stirring unit, 500.0 parts by mass of acetone and 500.0 parts by mass of amorphous resin 1 were inserted. The amorphous resin 1 was completely dissolved in acetone by being stirred at 40° C. to prepare an amorphous resin solution 1.

### <Preparation of Resin Fine Particle Dispersion Liquid 1>

First, 870.0 parts by mass of normal hexane was put into a two-neck flask that includes a dropping funnel and is dried by heating. Subsequently, 42.0 parts by mass of normal hexane, 52.0 parts by mass of behenyl acrylate (an acrylate of an alcohol having a linear alkyl group with 22 carbon atoms), and 0.3 parts by mass of azobismethoxydimethylvaleronitrile were put into another beaker and mixed by stirring at 20° C. to prepare a monomer solution. The monomer solution was introduced into the dropping funnel. After the reactor was purged with nitrogen, the monomer solution was dropped at 40° C. over 1 hour in a closed system. After the completion of dropping, stirring was performed for 3 hours. A mixture of 0.3 parts by mass of azobismethoxydimethylvaleronitrile and 42.0 parts by mass of normal hexane was dropped again, and stirring was performed at 40° C. for 3 hours. The temperature was decreased to room temperature, and a resin fine particle dispersion liquid 1 having a number-average particle diameter of 200 nm and a solid content of 20% by mass was obtained.

### <Preparation of Crystalline Polyester Dispersion Liquid 1>

| | |
|---|---|
| crystalline polyester 8 | 115.0 parts by mass |
| ionic surfactant Neogen RK (manufactured by | 5.0 parts by mass |
| DAI-ICHI KOGYO SEIYAKU Co., Ltd.) | |
| ion-exchange water | 180.0 parts by mass |

The above-described components were mixed with each other and heated to 100° C. The mixture was thoroughly dispersed using ULTRA-TURRAX T50 manufactured by IKA and then dispersed using a pressure discharge-type Gaulin homogenizer for 1 hour. Thus, a crystalline polyester dispersion liquid 1 having a number-average particle diameter (D1) of 200 nm and a solid content of 40% by mass was obtained.

### <Preparation of Amorphous Resin Dispersion Liquid 1>

| | |
|---|---|
| amorphous resin 1 | 115.0 parts by mass |
| ionic surfactant Neogen RK (manufactured by | 5.0 parts by mass |
| DAI-ICHI KOGYO SEIYAKU Co., Ltd.) | |
| ion-exchange water | 180.0 parts by mass |

The above-described components were mixed with each other and heated to 100° C. The mixture was thoroughly dispersed using ULTRA-TURRAX T50 manufactured by IKA and then dispersed using a pressure discharge-type Gaulin homogenizer for 1 hour. Thus, an amorphous resin dispersion liquid 1 having a number-average particle diameter of 200 nm and a solid content of 40% by mass was obtained.

### <Preparation of Coloring Agent Dispersion Liquid 1>

| | |
|---|---|
| C.I. Pigment Blue 15:3 | 100.0 parts by mass |
| acetone | 150.0 parts by mass |
| glass bead (1 mm) | 300.0 parts by mass |

The above-described materials were inserted into a heat-resistant glass container and dispersed using a paint shaker (Toyo Seiki Seisaku-sho, Ltd.) for 5 hours. The glass beads were removed with a nylon mesh to obtain a coloring agent dispersion liquid 1.

### <Preparation of Coloring Agent Dispersion Liquid 2>

| | |
|---|---|
| C.I. Pigment Blue 15:3 | 45.0 parts by mass |
| ionic surfactant Neogen RK (manufactured by | 5.0 parts by mass |
| DAI-ICHI KOGYO SEIYAKU Co., Ltd.) | |
| ion-exchange water | 200.0 parts by mass |

The above-described materials were inserted into a heat-resistant glass container and dispersed using a paint shaker for 5 hours. The glass beads were removed with a nylon mesh to obtain a coloring agent dispersion liquid 2.

### <Preparation of Wax Dispersion Liquid 1>

| | |
|---|---|
| carnauba wax (melting point: 81° C.) | 16.0 parts by mass |
| styrene-acrylic resin having a nitrile group | 8.0 parts by mass |
| (styrene: 60 parts by mass, n-butyl acrylate: | |
| 30 parts by mass, acrylonitrile: 10 parts by | |
| mass, peak molecular weight: 8500) | |
| acetone | 76.0 parts by mass |

The above-described materials were inserted into a glass beaker (manufactured by Iwaki Glass Co., Ltd.) including an impeller. The carnauba wax was dissolved in acetone by heating the system to 70° C.

Subsequently, the system was gradually cooled to 25° C. over 3 hours while being gently stirred at 50 rpm to obtain a milk-white solution.

This solution was inserted into a heat-resistant container together with 20 parts by mass of glass beads having a size of 1 mm and dispersed using a paint shaker for 3 hours to obtain a wax dispersion liquid 1.

The particle diameter of the wax in the wax dispersion liquid 1 was measured with a Microtrac particle-diameter distribution analyzer HRA (X-100) (manufactured by NIKKISO Co., Ltd.). The number-average particle diameter was 200 nm.

### <Preparation of Wax Dispersion Liquid 2>

| | |
|---|---|
| paraffin wax (HNP10 manufactured by NIPPON | 45.0 parts by mass |
| SEIRO Co., Ltd., melting point: 75° C.) | |
| cationic surfactant Neogen RK (manufactured by | 5.0 parts by mass |
| DAI-ICHI KOGYO SEIYAKU Co., Ltd.) | |
| ion-exchange water | 200.0 parts by mass |

The above-described materials were mixed with each other and heated to 95° C. The mixture was thoroughly dispersed using ULTRA-TURRAX T50 manufactured by IKA and then dispersed using a pressure discharge-type Gaulin homogenizer. Thus, a wax dispersion liquid 2 having a number-average particle diameter (D1) of 200 nm and a solid content of 25% by mass was obtained.

### Example 1

### Production of Toner Particles (Before Treatment)

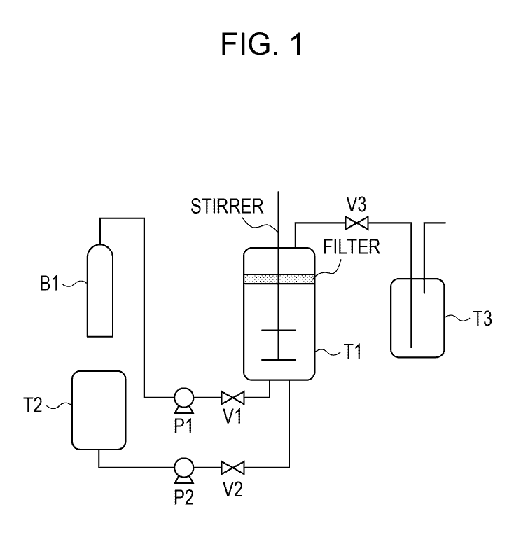

In the experimental apparatus shown in FIG. 1, valves V1 and V2 and a pressure-controlling valve 3 were closed. The resin fine particle dispersion liquid 1 was put into a pressure-resistant granulation tank T1 including a stirring mechanism and a filter for filtering toner particles. The internal temperature was adjusted to 30° C. Subsequently, the valve V1 was opened to introduce carbon dioxide (purity: 99.99%) to the pressure-resistant granulation tank T1 from a cylinder B1 using a pump P1. When the internal pressure reached 5 MPa, the valve V1 was closed.

The block polymer resin solution 1, the wax dispersion liquid 1, the coloring agent dispersion liquid 1, and acetone were put into a resin solution tank T2, and the internal temperature was adjusted to 30° C.

The valve V2 was then opened to introduce the contents of the resin solution tank T2 to the granulation tank T1 using a pump P2 while the inside of the granulation tank T1 was stirred at 2000 rpm. When the contents were completely introduced, the valve V2 was closed.

After the introduction, the internal pressure of the granulation tank T1 was 8 MPa.

The amounts of the various materials on a mass basis were as follows.

| | |
|---|---|
| block polymer resin solution 1 | 160.0 parts by mass |
| wax dispersion liquid 1 | 62.5 parts by mass |
| coloring agent dispersion liquid 1 | 25.0 parts by mass |
| acetone | 35.0 parts by mass |
| resin fine particle dispersion liquid 1 | 25.0 parts by mass |
| carbon dioxide | 320.0 parts by mass |

The density of carbon dioxide at 30° C. and 8 MPa was calculated from the equation of state described in Document (Journal of Physical and Chemical Reference data, vol. 25, P. 1509 to 1596). The mass of carbon dioxide introduced was calculated by multiplying the density by the volume of the granulation tank T1.

After the contents of the resin solution tank T2 were introduced to the granulation tank T1, stirring was performed at 2000 rpm for 3 minutes to cause granulation.

Subsequently, the valve V1 was opened to introduce carbon dioxide to the granulation tank T1 from the cylinder B1 using the pump P1. Herein, the pressure-controlling valve V3 was adjusted to be 10 MPa, and carbon dioxide was further caused to flow while the internal pressure of the granulation tank T1 was kept at 10 MPa. Through this process, carbon dioxide containing an organic solvent (mainly acetone) extracted from droplets after the granulation was discharged to a solvent recovery tank T3. The organic solvent and the carbon dioxide were then separated from each other.

When the mass of the carbon dioxide introduced to the granulation tank T1 reached five times the mass of the carbon dioxide initially introduced to the granulation tank T1, the introduction of the carbon dioxide was stopped. At this point, carbon dioxide containing an organic solvent was completely replaced with carbon dioxide not containing an organic solvent.

Furthermore, the pressure-controlling valve V3 was gradually opened to reduce the internal pressure of the granulation tank T1 to atmospheric pressure. Thus, filtered toner particles (before treatment) 1 were collected. The resultant toner particles (before treatment) 1 were subjected to DSC measurement. The peak temperature of the maximum endothermic peak was 58° C.

### (Annealing Treatment)

An annealing treatment was performed using a constant temperature drying furnace (41-S5 manufactured by Satake Chemical Equipment Mfg Ltd.). The internal temperature of the constant temperature drying furnace was adjusted to 51° C.

The toner particles (before treatment) 1 were placed on a stainless tray so as to be uniformly spread. This tray was inserted into the constant temperature drying furnace. The tray was left to stand for 12 hours and then taken out. Thus, annealed toner particles (after treatment) 1 were obtained.

### (Preparation Process of Toner 1)

Relative to 100 parts by mass of the toner particles (after treatment) 1, 1.8 parts by mass of hydrophobic silica fine powder treated with hexamethyldisilazane (number-average primary particle diameter: 7 nm) and 0.15 parts by mass of rutile titanium oxide fine powder (number-average primary particle diameter: 30 nm) were mixed with each other for 5 minutes through a dry process using a Henschel mixer (manufactured by NIPPON COKE & ENGINEERING. Co., Ltd.) to obtain a toner 1 according to an aspect of the present invention. Table 5 shows the physical properties of the toner 1.

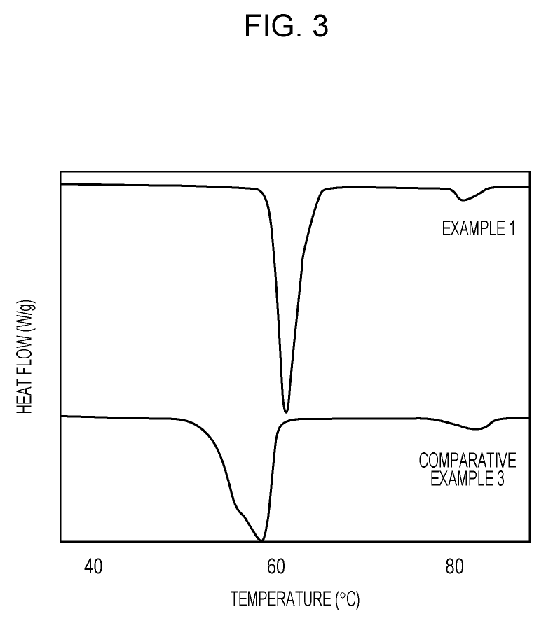

In the endothermic curve of the toner 1 measured with a differential scanning calorimeter, the maximum endothermic peak did not overlap the endothermic peak derived from the wax. Therefore, in the analysis, the maximum endothermic peak was regarded as an endothermic peak derived from the binder resin. FIG. 3 shows a DSC curve of the toner 1.

The following evaluations were conducted on the obtained toner. Table 6 shows the evaluation results.

### (1) Low-Temperature Fixability

The low-temperature fixability was evaluated using a commercially available printer LBP5300 manufactured by CANON KABUSHIKI KAISHA. LBP5300 employs a single-component contact development and regulates the amount of toner on a development carrier using a toner regulation member. A cartridge for evaluation was prepared by removing a toner in a commercially available cartridge, cleaning the inside of the cartridge by air blow, and filling the cartridge with the obtained toner. The resultant cartridge was left to stand at normal temperature and humidity (23° C./60%) for 24 hours. The cartridge was installed in the cyan station of LBP5300 and dummy cartridges were installed in other stations. Subsequently, an unfixed toner image (the amount of toner loaded per unit area: 0.6 mg/cm²) was formed on plain paper for copier (81.4 g/m²) and cardboard (157 g/m²).

A fixing device of a commercially available printer LBP5900 manufactured by CANON KABUSHIKI KAISHA was converted so that the fixing temperature could be set by hand. Thus, the rotational speed of the fixing device was changed to 245 mm/s and the nip pressure was changed to 98 kPa. In an environment of normal temperature and humidity, by increasing the fixing temperature 5° C. at a time in the range of 80° C. to 150° C., a fixed image of the above-described unfixed image at each of the fixing temperatures was obtained using the converted fixing device.

Soft thin paper (e.g., product name “Dusper” manufactured by OZU CORPORATION) was placed on an image region of the obtained fixed image. The image region was rubbed 5 times while a load of 4.9 kPa was applied to the image region through the thin paper. The image densities before and after the rubbing were measured, and the reduction percentage ΔD (%) of the image density was calculated from the formula below. A temperature at which ΔD (%) was less than 10% was defined as a fixing initiation temperature, which was used as an indicator for evaluating the low-temperature fixability. The image density was measured with a color reflection densitometer X-Rite 404A manufactured by X-Rite.

ΔD (%)={(Image density before rubbing−Image density after rubbing)/Image density before rubbing}×100

Furthermore, the same test was conducted using a cartridge stored in a severe environment of 40° C. and 95% RH for 50 days, instead of the cartridge stored at normal temperature and humidity.

### (2) Thermal Storage Resistance

About 10 g of the toner 1 was inserted into a 100 mL poly cup and left to stand for 3 days in a constant temperature oven at 50° C. and in a constant temperature oven at 53° C. After that, the toner 1 was evaluated through visual inspection. The evaluation criteria of the thermal storage resistance was shown below.

A: No aggregates are observed, which is the same state as the initial state.
B: Aggregation is slightly caused, but is disentangled by lightly shaking the poly cup about five times.
C: Aggregation is caused, but is easily disentangled by being loosened with a finger.
D: Aggregation is severely caused.
E: Toner is solidified and cannot be used.

### (3) Image Density

A fixed image (solid image) was formed on color laser copier paper manufactured by CANON KABUSHIKI KAISHA using a commercially available printer LBP5300 manufactured by CANON KABUSHIKI KAISHA in a high-temperature and humidity environment (30° C./80% RH). The amount of toner loaded was adjusted to 0.35 mg/cm².

The resultant image density was evaluated using a reflection densitometer (500 Series Spectrodensitometer) manufactured by X-Rite.

### Examples 2 to 17 and 19

Toners 2 to 17 and 19 were produced in the same manner as in Example 1, except that the types of resins used and the annealing conditions were changed to those shown in Table 4. Table 5 shows the physical properties of the resultant toners. Table 6 shows the results of the same evaluation as that conducted in Example 1.

In the endothermic curve of the toners 5 and 9, the maximum endothermic peak overlapped the endothermic peak derived from the wax. Therefore, in the analysis, the endothermic amount derived from the wax was subtracted from the maximum endothermic peak.

### Example 18

Toner particles (before treatment) 18 were produced in the same manner as in Example 1, except that the amount of each component in the production process of the toner particles (before treatment) 1 was changed to be as follows.

| | |
|---|---|
| crystalline polyester resin solution 1 | 112.0 parts by mass |
| amorphous resin solution 1 | 48.0 parts by mass |
| wax dispersion liquid 1 | 62.5 parts by mass |
| coloring agent dispersion liquid 1 | 25.0 parts by mass |
| acetone | 35.0 parts by mass |
| resin fine particle dispersion liquid 1 | 25.0 parts by mass |
| carbon dioxide | 320.0 parts by mass |

The resultant toner particles (before treatment) 18 were subjected to DSC measurement. The peak temperature of the maximum endothermic peak was 65° C.

A toner 18 was produced by performing an annealing treatment on the resultant toner particles (before treatment) 18 in the same manner as in Example 1, except that the annealing temperature was changed to 58° C.

Table 5 shows the physical properties of the resultant toner. Table 6 shows the results of the same evaluation as that conducted in Example 1.

### Comparative Example 1

### Production Process of Comparative Toner Particles 1

| | |
|---|---|
| crystalline polyester dispersion liquid 1 | 109 parts by mass |
| amorphous resin dispersion liquid 1 | 104 parts by mass |
| coloring agent dispersion liquid 2 | 28 parts by mass |
| wax dispersion liquid 2 | 46 parts by mass |
| polyaluminum chloride | 0.41 parts by mass |

The above-described components were put into a round-bottomed stainless flask and thoroughly mixed and dispersed using ULTRA-TURRAX T50. Subsequently, 0.36 parts by mass of polyaluminum chloride was added thereto and further dispersed using ULTRA-TURRAX T50. The mixture was heated to 47° C. with an oil bath for heating while being stirred, and was kept at that temperature for 60 minutes. The amorphous resin fine particle dispersion liquid 1 was gently added to the mixture in an amount of 30 parts by mass. After pH of the solution was adjusted to 5.4 with a 0.5 mol/L aqueous sodium hydroxide solution, the stainless flask was sealed, heated to 96° C. while stirring was continued by using magnetic seal, and retained for 5 hours.

Upon the completion of the reaction, the mixture was cooled, filtered, thoroughly washed with ion-exchange water, subjected to solid-liquid separation by Nutsche suction filtration, and redispersed in 3 L of ion-exchange water at 40° C. Then, stirring and washing were performed at 300 rpm for 15 minutes. This operation was further repeated five times. When pH of the filtrate reached 7.0, solid-liquid separation was performed using a No. 5A paper filter by Nutsche suction filtration. Subsequently, vacuum drying was continued for 12 hours. As a result, comparative toner particles 1 were obtained.

An external additive was added to the comparative toner particles 1 in the same manner as in Example 1 to obtain a comparative toner 1.

Table 5 shows the physical properties of the resultant toner. Table 6 shows the results of the same evaluation as that conducted in Example 1.

### Comparative Example 2

A comparative toner 2 was produced in the same manner as in Comparative Example 1, except that the amounts of the crystalline polyester dispersion liquid 1 and the amorphous resin dispersion liquid 1 added initially in Comparative Example 1 were changed to 170 parts by mass and 43 parts by mass, respectively.

Table 5 shows the physical properties of the resultant toner. Table 6 shows the results of the same evaluation as that conducted in Example 1.

### Comparative Example 3

A comparative toner 3 was produced in the same manner as in Example 1, except that the toner particles (before treatment) 1 were not annealed in Example 1.

Table 5 shows the physical properties of the resultant toner. FIG. 3 shows a DSC curve of the comparative toner 3. Table 6 shows the results of the same evaluation as that conducted in Example 1.

### Reference Examples 1 to 4

Reference toners 1 to 4 were produced in the same manner as in Example 1, except that the types of resins used and the annealing conditions were changed to those shown in Table 4.

Table 5 shows the physical properties of the resultant toners. Table 6 shows the results of the same evaluation as that conducted in Example 1.

TABLE 4

| | | | | Endothermic peak | Annealing treatment | | |
|---|---|---|---|---|---|---|---|
| | | | | temperature of toner | | | Endothermic peak |
| | | | | particles | Treatment | | temperature of |
| | | | | (before treatment) | temperature | Treatment | toner particles (after |
| | | Used resin | | (° C.) | (° C.) | time (hour) | treatment) (° C.) |
| Ex. 1 | Toner 1 | Block polymer 1 | — | 58 | 51 | 12 | 61 |
| Ex. 2 | Toner 2 | Block polymer 2 | — | 53 | 46 | 12 | 56 |
| Ex. 3 | Toner 3 | Block polymer 3 | — | 66 | 59 | 12 | 69 |
| Ex. 4 | Toner 4 | Block polymer 4 | — | 50 | 43 | 12 | 53 |
| Ex. 5 | Toner 5 | Block polymer 5 | — | 75 | 68 | 12 | 78 |
| Ex. 6 | Toner 6 | Block polymer 6 | — | 58 | 51 | 12 | 61 |
| Ex. 7 | Toner 7 | Block polymer 7 | — | 58 | 51 | 12 | 61 |
| Ex. 8 | Toner 8 | Block polymer 8 | — | 50 | 43 | 12 | 53 |
| Ex. 9 | Toner 9 | Block polymer 9 | — | 75 | 68 | 12 | 78 |
| Ex. 10 | Toner 10 | Block polymer 10 | — | 58 | 51 | 12 | 61 |
| Ex. 11 | Toner 11 | Block polymer 11 | — | 58 | 51 | 12 | 61 |
| Ex. 12 | Toner 12 | Block polymer 12 | — | 58 | 51 | 12 | 61 |
| Ex. 13 | Toner 13 | Block polymer 13 | — | 58 | 51 | 12 | 61 |
| Ex. 14 | Toner 14 | Block polymer 1 | — | 58 | 48 | 2 | 60 |
| Ex. 15 | Toner 15 | Block polymer 1 | — | 58 | 46 | 2 | 60 |
| Ex. 16 | Toner 16 | Block polymer 1 | — | 58 | 46 | 1 | 60 |
| Ex. 17 | Toner 17 | Block polymer 1 | — | 58 | 46 | 0.5 | 60 |
| Ex. 18 | Toner 18 | Crystalline polyester 8 | Amorphous resin 1 | 65 | 58 | 12 | 66 |
| Ex. 19 | Toner 19 | Block polymer 14 | — | 58 | 51 | 12 | 61 |
| C. E. 1 | Comparative toner 1 | Crystalline polyester 8 | Amorphous resin 1 | 65 | — | — | — |
| C. E. 2 | Comparative toner 2 | Crystalline polyester 8 | Amorphous resin 1 | 65 | — | — | — |
| C. E. 3 | Comparative toner 3 | Block polymer 1 | — | 58 | — | — | — |
| R. E. 1 | Reference toner 1 | Block polymer 15 | — | 42 | 35 | 12 | 45 |
| R. E. 2 | Reference toner 2 | Block polymer 16 | — | 79 | 72 | 12 | 82 |
| R. E. 3 | Reference toner 3 | Block polymer 17 | — | 58 | 51 | 12 | 61 |
| R. E. 4 | Reference toner 4 | Block polymer 18 | — | 58 | 51 | 12 | 61 |

Ex.: Example
C.E.: Comparative Example
R.E.: Reference Example

TABLE 5

| | Endothermic properties | | | | | | | | | |
|---|---|---|---|---|---|---|---|---|---|---|
| | Tp (° C.) | ΔH (J/g) | ΔH_{Tp}/ΔH | ΔH_{Tp-3}/ΔH | Half width (° C.) | Mn | Mw | Mw/Mn | D4 (μm) | D4/D1 |
| Ex. 1 | 61 | 43 | 0.42 | 0.01 | 2.4 | 15700 | 33700 | 2.1 | 5.5 | 1.16 |
| Ex. 2 | 56 | 43 | 0.42 | 0.01 | 2.5 | 15100 | 32800 | 2.2 | 5.6 | 1.18 |
| Ex. 3 | 69 | 43 | 0.42 | 0.01 | 2.5 | 15800 | 30800 | 1.9 | 5.4 | 1.22 |
| Ex. 4 | 53 | 43 | 0.41 | 0.01 | 2.4 | 14400 | 30900 | 2.1 | 5.7 | 1.21 |
| Ex. 5 | 78 | 43 | 0.42 | 0.01 | 2.4 | 15800 | 35000 | 2.2 | 6.1 | 1.22 |
| Ex. 6 | 61 | 78 | 0.42 | 0.02 | 2.4 | 13900 | 30600 | 2.2 | 5.7 | 1.19 |
| Ex. 7 | 61 | 32 | 0.43 | 0.02 | 2.4 | 13000 | 29100 | 2.2 | 5.3 | 1.18 |
| Ex. 8 | 53 | 32 | 0.42 | 0.01 | 2.4 | 12800 | 24600 | 1.9 | 5.5 | 1.22 |
| Ex. 9 | 78 | 78 | 0.41 | 0.01 | 2.4 | 14000 | 33000 | 2.4 | 5.5 | 1.23 |
| Ex. 10 | 61 | 43 | 0.42 | 0.02 | 2.3 | 9600 | 19700 | 2.1 | 5.6 | 1.25 |
| Ex. 11 | 61 | 43 | 0.41 | 0.01 | 2.5 | 7000 | 14800 | 2.1 | 5.8 | 1.24 |
| Ex. 12 | 61 | 43 | 0.36 | 0.01 | 3.6 | 28000 | 57700 | 2.1 | 5.9 | 1.20 |
| Ex. 13 | 61 | 43 | 0.31 | 0.01 | 4.3 | 39400 | 72900 | 1.9 | 5.3 | 1.21 |
| Ex. 14 | 60 | 43 | 0.47 | 0.09 | 3.2 | 15700 | 33600 | 2.1 | 5.4 | 1.22 |
| Ex. 15 | 60 | 42 | 0.48 | 0.12 | 4.0 | 15700 | 33700 | 2.1 | 5.6 | 1.23 |
| Ex. 16 | 60 | 42 | 0.49 | 0.18 | 4.9 | 15800 | 33700 | 2.1 | 5.8 | 1.20 |
| Ex. 17 | 60 | 42 | 0.49 | 0.19 | 5.2 | 15700 | 33400 | 2.1 | 5.9 | 1.18 |
| Ex. 18 | 66 | 57 | 0.48 | 0.18 | 4.7 | 11000 | 47000 | 4.3 | 6.1 | 1.19 |
| Ex. 19 | 61 | 88 | 0.42 | 0.03 | 2.5 | 12500 | 28200 | 2.3 | 6.0 | 1.20 |
| C. E. 1 | 65 | 26 | 0.65 | 0.29 | 6.3 | 10000 | 38100 | 3.8 | 5.7 | 1.21 |
| C. E. 2 | 65 | 62 | 0.62 | 0.27 | 5.8 | 11000 | 47000 | 4.3 | 6.0 | 1.22 |
| C. E. 3 | 58 | 50 | 0.53 | 0.22 | 5.1 | 15800 | 33600 | 2.1 | 5.8 | 1.24 |
| R. E. 1 | 45 | 43 | 0.43 | 0.02 | 2.4 | 15100 | 34300 | 2.3 | 5.5 | 1.22 |
| R. E. 2 | 82 | 43 | 0.42 | 0.02 | 2.6 | 15000 | 32800 | 2.2 | 5.6 | 1.21 |
| R. E. 3 | 61 | 28 | 0.42 | 0.02 | 3.4 | 18400 | 41300 | 2.2 | 5.4 | 1.23 |
| R. E. 4 | 61 | 43 | 0.28 | 0.02 | 4.8 | 15800 | 97800 | 6.2 | 5.6 | 1.22 |

Ex.: Example
C.E.: Comparative Example
R.E.: Reference Example

TABLE 6

| | Low-temperature fixability | | | | | | | | |
|---|---|---|---|---|---|---|---|---|---|
| | | | | | Difference in fixing | | | | |
| | Evaluation A: left to stand | | | | temperature between | | | | |
| | at normal temperature | | Evaluation B: stored at | | before and after storage | | Thermal | | |
| | and humidity for 24 hours | | 40° C. and 95% RH | | (Evaluation B − | | storage | | |
| | (° C.) | | for 50 days (° C.) | | Evaluation A) (° C.) | | resistance | | Image |
| | Plain paper | Cardboard | Plain paper | Cardboard | Plain paper | Cardboard | 50° C. | 53° C. | density |
| Ex. 1 | 100 | 100 | 100 | 100 | 0 | 0 | A | A | 1.63 |
| Ex. 2 | 95 | 100 | 95 | 100 | 0 | 0 | A | B | 1.62 |
| Ex. 3 | 105 | 110 | 105 | 110 | 0 | 0 | A | A | 1.61 |
| Ex. 4 | 90 | 100 | 90 | 100 | 0 | 0 | B | C | 1.47 |
| Ex. 5 | 115 | 120 | 115 | 120 | 0 | 0 | A | A | 1.63 |
| Ex. 6 | 100 | 100 | 100 | 100 | 0 | 0 | A | A | 1.45 |
| Ex. 7 | 110 | 120 | 110 | 120 | 0 | 0 | A | A | 1.66 |
| Ex. 8 | 100 | 105 | 100 | 105 | 0 | 0 | B | C | 1.49 |
| Ex. 9 | 115 | 120 | 115 | 120 | 0 | 0 | A | A | 1.45 |
| Ex. 10 | 100 | 100 | 100 | 100 | 0 | 0 | A | B | 1.59 |
| Ex. 11 | 100 | 100 | 100 | 100 | 0 | 0 | A | C | 1.49 |
| Ex. 12 | 105 | 115 | 105 | 115 | 0 | 0 | A | A | 1.61 |
| Ex. 13 | 110 | 120 | 110 | 120 | 0 | 0 | A | A | 1.60 |
| Ex. 14 | 100 | 105 | 100 | 110 | 0 | 5 | A | A | 1.60 |
| Ex. 15 | 100 | 105 | 105 | 110 | 5 | 5 | A | B | 1.59 |
| Ex. 16 | 100 | 105 | 105 | 115 | 5 | 10 | A | B | 1.58 |
| Ex. 17 | 100 | 105 | 110 | 120 | 10 | 15 | B | B | 1.58 |
| Ex. 18 | 105 | 110 | 110 | 120 | 5 | 10 | B | C | 1.45 |
| Ex. 19 | 100 | 100 | 100 | 100 | 0 | 0 | A | A | 1.42 |
| C. E. 1 | 115 | 125 | 125 | 135 | 10 | 10 | B | D | 1.43 |
| C. E. 2 | 100 | 105 | 120 | 125 | 20 | 20 | B | D | 1.32 |
| C. E. 3 | 100 | 105 | 115 | 125 | 15 | 20 | B | C | 1.47 |
| R. E. 1 | 90 | 95 | 90 | 95 | 0 | 0 | D | E | 1.38 |
| R. E. 2 | 120 | 130 | 120 | 130 | 0 | 0 | A | A | 1.62 |
| R. E. 3 | 115 | 125 | 115 | 125 | 0 | 0 | A | A | 1.63 |
| R. E. 4 | 115 | 125 | 115 | 130 | 0 | 5 | A | A | 1.45 |

Ex.: Example
C.E.: Comparative Example
R.E.: Reference Example

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

T1 granulation tank
T2 resin solution tank
T3 solvent recovery tank
B1 carbon dioxide cylinder
P1, P2 pump
V1, V2 valve
V3 pressure-controlling valve

1. A method for producing a toner comprising toner particles, each of which comprises a binder resin, a coloring agent, and a wax,
the binder resin comprising a resin (a),
the resin (a) containing a crystalline polyester segment in an amount of 50% or more by mass relative to the total amount of the resin (a), and
the method comprising the steps of:
preparing a resin solution comprising the binder resin, the coloring agent, the wax, and an organic solvent;
dispersing the resin solution in a medium to form oil droplets;
removing the organic solvent to obtain unannealed-toner-particles; and
annealing the unannealed-toner-particles at a temperature between 15° C. lower than the endothermic peak temperature of the crystalline polyester segment and 5° C. lower than the endothermic peak temperature of the crystalline polyester segment, to obtain the toner particles;
wherein, when an endothermic amount of the toner is measured with a differential scanning calorimeter,
(1) an endothermic peak temperature (Tp) derived from the binder resin is 50° C. or higher and 80° C. or lower;
(2) a total endothermic amount (ΔH) derived from the binder resin is 30 [J/g] or more and 125 [J/g] or less based on mass of the binder resin;
(3) when an endothermic amount derived from the binder resin from an initiation temperature of an endothermic process to Tp is represented by ΔH_{Tp} [J/g], ΔH and ΔH_{Tp} satisfy formula (1) below; and
(4) when an endothermic amount derived from the binder resin from the initiation temperature of an endothermic process to a temperature 3.0° C. lower than Tp is represented by ΔH_{Tp-3} [J/g], ΔH and ΔH_{Tp-3} satisfy formula (2) below:
0.30≦ΔH_{Tp}/ΔH≦0.50 (1)
0.00≦ΔH_{Tp-3}/ΔH≦0.20 (2).

2. The method according to claim 1, wherein the toner has a number-average molecular weight (Mn) of 8000 or more and 30000 or less and a weight-average molecular weight (Mw) of 15000 or more and 60000 or less, Mn and Mw being obtained from gel permeation chromatography measurement of tetrahydrofuran soluble matter of the toner.

3. The method according to claim 1, wherein the resin (a) contains a block polymer having the crystalline polyester segment.

4. The method according to claim 1, wherein the resin (a) contains a block polymer having the crystalline polyester segment and a segment not forming a crystalline structure bonded with each other through a urethane bond.

5. The method according to claim 1, wherein ΔH and ΔH_{Tp-3} [J/g] satisfies formula (3) below:
0.00≦ΔH_{Tp-3}/ΔH≦0.10 (3).

6. The method according to claim 1, wherein the total endothermic amount (ΔH) derived from the binder resin is 30 [J/g] or more and 80 [J/g] or less.

7. The method according to claim 1, wherein a half width of an endothermic curve derived from the binder resin is 5.0° C. or lower.

8. The method according to claim 1, wherein the medium is liquid or supercritical carbon dioxide.

9. A method for producing a toner comprising toner particles, each of which comprises a binder resin, a coloring agent, and a wax,
the method comprising the steps of:
preparing a resin solution comprising the binder resin, the coloring agent, the wax, and an organic solvent;
dispersing the resin solution in a medium to form oil droplets;
removing the organic solvent to obtain unannealed-toner-particles, each of which comprises the binder resin, the binder resin comprising a resin (a), the resin (a) containing a segment capable of forming a crystalline structure in an amount of 50% or more by mass relative to the total amount of the resin (a), and
annealing the unannealed-toner-particles at a temperature between 15° C. lower than the endothermic peak temperature of the segment capable of forming a crystalline structure and 5° C. lower than the endothermic peak temperature of the segment capable of forming a crystalline structure, to obtain the toner particles comprising a crystalline polyester segment; wherein, when an endothermic amount of the toner is measured with a differential scanning calorimeter,
(1) an endothermic peak temperature (Tp) derived from the binder resin is 50° C. or higher and 80° C. or lower;
(2) a total endothermic amount (ΔH) derived from the binder resin is 30 [J/g] or more and 125 [J/g] or less based on mass of the binder resin;
(3) when an endothermic amount derived from the binder resin from an initiation temperature of an endothermic process to Tp is represented by ΔH_{Tp} [J/g], ΔH and ΔH_{Tp} satisfy formula (1) below; and
(4) when an endothermic amount derived from the binder resin from the initiation temperature of an endothermic process to a temperature 3.0° C. lower than Tp is represented by ΔH_{Tp-3} [J/g], ΔH and ΔH_{Tp-3} satisfy formula (2) below
0.30≦ΔH_{Tp}/ΔH≦0.50 (1)
0.00≦ΔH_{Tp-3}/ΔH≦0.20 (2).
